(19) United States
(12) Patent Application Publication
(10) Pub. No.: US 2007/0168382 A1
(43) Pub. Date: Jul. 19, 2007

(54) Document analysis system for integration of paper records into a searchable electronic database

(76) Inventors: Michael Tillberg, Brentwood, NH (US); George L. Gaines III, Boxford, MA (US)

Correspondence Address: NORMA E HENDERSON;HENDERSON PATENT LAW, 13 JEFFERSON DR, LONDONDERRY, NH, 03053, US

(21) Appl. No.: 11/649,192

(22) Filed: Jan. 3, 2007

Related U.S. Application Data
(60) Provisional application No. 60/755,294, filed on Jan. 3, 2006.
(60) Provisional application No. 60/834,319, filed on Jul. 31, 2006.

(51) Int. Cl. G06F 7/00

(52) U.S. Cl. 707/102

(57) ABSTRACT

Electronic extraction of information from fields within documents comprises identifying a document by comparison to a template library, identifying data fields based on size and position, extracting data from the fields, and applying recognition. Line identification employs shaded region identification, line capture and gap filling, line segment clustering, and optional line rotation. Fingerprinting methods compare line segments found in a document with line definitions for templates to identify the template that best matches the document. Templates for new form types are defined by identifying and determining a location and size for lines, boxes, or shaded regions located within the form. Form fields based on location are then defined, any text within each field is recognized, and field identifiers and content descriptors are assigned and stored to define the template. Identification of unmatched documents is facilitated by clustering unidentified documents for use in identification or creation of a new form template.

### RELATED APPLICATIONS

This application claims the benefit of U.S. Provisional Application Ser. No. 60/755,294, filed Jan. 3, 2006, and U.S. Provisional Application Ser. No. 60/834,319 filed Jul. 31, 2006, the entire disclosures of which are herein incorporated by reference in their entirety.

### STATEMENT REGARDING FEDERALLY SPONSORED RESEARCH OR DEVELOPMENT

This invention was made with U.S. government support under Grant Number TATRC# W81XWH-05-C-0106, awarded by the Department of Defense. The government has certain rights in this invention.

### INCORPORATION BY REFERENCE OF MATERIAL SUBMITTED ON A COMPACT DISC

This application contains a computer program listing appendix submitted on compact disc under the provisions of 37 CFR 1.96 and herein incorporated by reference. The machine format of this compact disc is IBM-PC and the operating system compatibility is Microsoft Windows. The computer program listing appendix includes, in ASCII format, the files listed in Table 1:

TABLE 1

| | | Size |
|---|---|---|
| File name | Creation Date | in bytes |
| AffineImageAlignment.java.txt | Dec. 31, 2006 9:41 PM | 7 KB |
| AlgorithmFactory.java.txt | Dec. 31, 2006 9:42 PM | 2 KB |
| Box.java.txt | Dec. 31, 2006 9:43 PM | 7 KB |
| Cluster.java.txt | Dec. 31, 2006 9:43 PM | 17 KB |
| ClusterAlignment.java.txt | Dec. 31, 2006 9:43 PM | 3 KB |
| ClusterAlignmentAlgorithm.java.txt | Dec. 31, 2006 9:43 PM | 2 KB |
| ClusterGraph.java.txt | Dec. 31, 2006 9:43 PM | 14 KB |
| ClusterPosComparator.java.txt | Dec. 31, 2006 9:44 PM | 1 KB |
| ClusterScorer.java.txt | Dec. 31, 2006 9:44 PM | 5 KB |
| ClusterScoringAlgorithm.java.txt | Dec. 31, 2006 9:44 PM | 2 KB |
| ClusterUIF.java.txt | Dec. 31, 2006 9:53 PM | 13 KB |
| Configurable.java.txt | Dec. 31, 2006 9:44 PM | 1 KB |
| ConfigurableImpl.java.txt | Dec. 31, 2006 9:44 PM | 1 KB |
| Configuration.java.txt | Dec. 31, 2006 9:45 PM | 21 KB |
| Coordinate.java.txt | Dec. 31, 2006 9:52 PM | 4 KB |
| Dashboardv5.2.js.txt | Nov. 25, 2006 11:58 AM | 20 KB |
| DefMaker.java.txt | Dec. 31, 2006 9:53 PM | 35 KB |
| DeskewImageAlignment.java.txt | Dec. 31, 2006 9:45 PM | 13 KB |
| DynamicProgClusterAligner.java.txt | Dec. 31, 2006 9:45 PM | 22 KB |
| Form.java.txt | Dec. 31, 2006 9:46 PM | 54 KB |
| FormAlignment.java.txt | Dec. 31, 2006 9:46 PM | 19 KB |
| FormAlignmentAlgorithm.java.txt | Dec. 31, 2006 9:46 PM | 1 KB |
| FPTestGen.java.txt | Dec. 31, 2006 9:54 PM | 45 KB |
| ImageAlignmentAlgorithm.java.txt | Dec. 31, 2006 9:46 PM | 2 KB |
| ImageMarkEngine.java.txt | Dec. 31, 2006 9:55 PM | 16 KB |
| IteratingFormAlignment.java.txt | Dec. 31, 2006 9:47 PM | 3 KB |
| jsrunner.jsp.txt | Dec. 31, 2006 10:25 PM | 5 KB |
| LineExtractionAlgorithm.java.txt | Dec. 31, 2006 9:47 PM | 1 KB |
| LineExtractorjava.txt | Dec. 31, 2006 9:47 PM | 25 KB |
| OffsetFormAlignment.java.txt | Dec. 31, 2006 9:47 PM | 7 KB |
| PenDocument.java.txt | Dec. 31, 2006 9:52 PM | 17 KB |
| Point.java.txt | Dec. 31, 2006 9:47 PM | 5 KB |
| PointComparator.java.txt | Dec. 31, 2006 9:47 PM | 1 KB |
| PointList.java.txt | Dec. 31, 2006 9:48 PM | 3 KB |
| PreprocessAlgorithm.java.txt | Dec. 31, 2006 9:48 PM | 1 KB |
| PreprocessPipeline.java.txt | Dec. 31, 2006 9:48 PM | 4 KB |
| ProcessScan.java.txt | Dec. 31, 2006 9:48 PM | 34 KB |
| ProcessScanRunner.java.txt | Dec. 31, 2006 9:49 PM | 21 KB |
| RotatePreprocessor.java.txt | Dec. 31, 2006 9:49 PM | 4 KB |
| ScaleHackPreprocessor.java.txt | Dec. 31, 2006 9:49 PM | 2 KB |
| SingleFormAlignment.java.txt | Dec. 31, 2006 9:49 PM | 12 KB |
| StringAligner.java.txt | Dec. 31, 2006 9:55 PM | 13 KB |
| Stroke.java.txt | Dec. 31, 2006 9:52 PM | 15 KB |
| UnconstrainedClusterAligner.java.txt | Dec. 31, 2006 9:49 PM | 14 KB |

### FIELD OF THE TECHNOLOGY

The present invention relates to automated data extraction from documents and, in particular, to a process and set of computer applications that identify document types and versions, locates fields in those documents, and extracts the information from those fields.

### BACKGROUND

Currently there exists an enormous amount of information that is located on paper forms and documents. In general, this information is not readily available to computerized systems in its current state because the forms are captured and stored as whole images. An important aim of data capture and conversion is the integration of electronic data, i.e. data that is captured directly with keyboard, instrumental input or from databases, with the information that currently resides only on paper. Much of the increased interest in document management (both paper and electronic) is being driven by government and legal mandates, such as Sarbanes-Oxley and HIPAA. While these mandates are causing many organizations to develop and implement document management systems, there is also an increasing interest in not only simply archiving the information, but also in improving business processes and efficiencies by acquiring the ability to search and retrieve data from that archive.

In order to achieve increased efficiency in many business processes and work flows, processes that do more than just save whole images are required. Although having electronic copies of documents and forms can increase sharing of the documents and forms and thus reduce the costs associated with storage of paper hard copies, the data remains trapped and is often inaccessible without manual searching and extraction. In contrast, if the data within forms could be extracted in a contextual manner, meaning that the data or even just the image that corresponds to a specific piece of information could be extracted out of a form that contains a plurality of data, then that information might be retrieved and visualized without searching through the document or form. Furthermore, if the data or images could be extracted from the form while retaining the context of the data, more elaborate searches and data mining can be accomplished.

The development of computerized document and data storage capabilities over the past forty years has led to an evolution of information flow and storage from a paper based process to an electronic bit-based process. However, paper continues to be a major storage medium for information and data, both as structured forms and as unstructured documents. Between 1999 and 2002, the use of paper actually increased by roughly 36% worldwide. One of the challenges that remains in the evolution of data capture and storage is the transformation of the information that resides on paper media into an electronically accessible database system.

Currently, there are a number of industrial verticals that have remained wedded to paper-based data capture, despite intense efforts to move the systems to electronic data capture. Examples include the healthcare industry, where electronic medical records remain at a low level of acceptance, the insurance industry, where certain forms are still captured on paper and the workflow includes key stroking the paper-held data into databases, and many governmental agencies that, due to short term fiscal pressures and a multitude of form types, have not migrated to electronic data capture.

Even with advances in electronic data capture and archiving, many sectors, both private and public, still have huge amounts of paper data that needs to be warehoused and archived in a searchable manner. These paper records become more and more difficult to access and search, in part because of the sheer size of the data stores, as well as the reduction in head count dedicated to information retrieval. In addition, the amount of money spent on keying in data from paper records is currently estimated to exceed $15 B annually in the United States. Electronic archiving of paper records by means of scanning the documents and storing the resulting images alleviates the physical space requirements for paper storage and allows for rapid transfer of the documents; however, it does little to facilitate searching of the documents for specific information or data. Yet another $15 B is estimated to be spent annually on simply processing forms for archiving, search and retrieval.

The workflow for archiving documents depends largely upon the level of tagging or addition of metadata, i.e. explanations or notations about the content of the data contained within a document, to be provided for the scanned documents, as well as the nature of the documents themselves. Metadata may be used to search for documents or fields of interest if the metadata is stored in an appropriate manner and is linked to the document or field that it references. There are several levels of metadata that are usefuil in describing a document. Initially, the document is divided into a tree structure, in order to allow reuse of metadata descriptions that also represent the structure of a standard document, as shown in FIG. 1. The first step in developing metadata for a document is therefore to identify the type of the document. This is done first at the root level 110, providing metadata about the document in total. Next, each page 120 is categorized, thereby describing at a minimum the page numbers of the document. More information about the page may also be generated and saved, such as the type of structured document (Form XYZ, Page 3 of Document ABC, etc). Ultimately, metadata about the information contained within each page 120 and its location (field 130) is increasingly usefuil for later search and retrieval. Subfields 140 may also be located within fields 130, leading to multiple tiers of fields in the tree structure.

If little or no metadata is required and the documents consist of standard paper that is easily fed through a batch scanner, a single operator may scan thousands of pages of documents per day. The main bottleneck in this process is the manual quality control of scan integrity, pre-scan sorting, and document preparation. However, if more information about the documents is needed, then the data entry requirements increase dramatically. Even a limited amount of manual data entry may slow the scanning process ten-fold. Data entry and the required sorting rapidly becomes the key bottleneck in the scanning-and archiving process. Although, several solutions are available to minimize the manual entry of metadata for documents, none is capable of eliminating the data entry and sorting entirely.

A significant reduction in the amount of data that requires manual keystrokes for entry would alleviate the main bottleneck and speed the process of scanning and keying document metadata. In addition, a great amount of time is spent processing and converting forms by manual keying because of forms changing in structure, both over time for a given user and also between users that generate different forms for the same purpose, e.g., health insurers and health clinics. In order to capture this data, manual keying into a database is required; otherwise, this valuable source of information goes ignored.

Data and information stored in documents are generally organized in a set of hierarchical directories, either as paper pages in documents contained in folders within a filing system, or as electronic documents within electronic folders with multiple levels. Under these conditions of data storage, information within hierarchically-related documents is generally easy to find, given some time to flip through the related documents. However, the effort required initially for cataloging and saving the documents is substantial at both the paper and electronic level. Furthermore, information that is not relevant or related to the hierarchical storage schema is often made less accessible than data from documents stored in a less structured approach. In addition, as the filing system grows with the addition of documents, it is often advisable to alter the cataloging or classification approach, again requiring a great deal of time and effort. A process that allowed flexible tagging rather than a hierarchical storage system is a real advantage as the numbers of users and document and data sources increase. Rigid. labeling and storage renders large, diverse, and/or evolving systems difficult to use.

Information that only resides in paper presents a special challenge to the retrieval of that information. The scanning of the paper forms and documents allows the input of images of the documents into document management systems. These systems currently only allow searching at the document and page level and are not capable of searching and retrieving data at the field level. Furthermore, search and retrieval systems built within current document management systems require metadata tags for the scanned documents that, at a minimum, delimit the date of scan, the document type, and a minimal set of data about the contents. Standard scanning and archiving is not able to extract information about the data within the documents being scanned. In addition, the type or style of document is not recognized in standard scanning protocols, requiring data entry operators keying any relevant data on a per document basis. The entry of data via keyboard is a time consuming and expensive endeavor, and the manual activity is generally error prone, requiring further editing and quality control steps.

A common approach to extraction of data is the use of Optical Character Recognition (OCR) methods. These methods allow text contained within digitized images (scans, PDF documents, and the like) to be converted to machine text, such that the resulting strings of text may be operated upon by standard computer programs. OCR has multiple uses in the identification of forms and scans and the interpretation of the content within the forms. Existing commercial systems designed to index or identify form types use whole page or document OCR to generate a list of words or phrases from within the scanned form that can then be used to match against a unique list (often one of just a few words/phrases). Scanned documents that have those unique words/phrases are then determined to be the form type indicated by match. This approach has general utility, but suffers from several drawbacks, most importantly manifested by inefficiencies when OCR is poor. OCR results may be of low quality under many conditions, including, but not limited to, when the scanned text is in italics, the scans are of poor quality, there is overwriting of text when filled in by a user, and the scan is improperly oriented. Furthermore, the drawbacks include significant use of computing power to OCR each and every form completely, difficulty in scaling the number of form types indexed, false calls with large amounts of typed in text that may contain the same or reference the unique words/phrases, and difficulty in identifying versions of the same form type.

Despite the noted problems of OCR based form identification, some workflows may work well with OCR as the mechanism to identify unique properties (e.g. specific strings of text) for a form. OCR analysis, especially in a contextual manner may be particularly powerful and provide both an additive effect to accuracy of form identification using other methods as well as provide a validation of correct identification. However, form identification projects having large numbers of similar forms will suffer from reduced efficiency and accuracy. Paper documents and forms that are designed to capture information often undergo changes from time to time in both the structure and the content that is input. For example, these changes may be very subtle, such as a single line of a box being shifted in location to accommodate more input. At the other end of the spectrum, the changes can be extreme despite having the same form identity, such as when whole new data fields are added or subtracted with global shifts in structural relationships. Furthermore, the location of text may change position relative to data input boxes. Many of these changes may not occur at the same time, resulting in a set of the same forms with multiple versions.

U.S. Pat. No. 7,106,904 (Shima, “Form Identification Method”, Sept. 12, 2006) teaches methods for identifying forms even when the forms are input in different orientations or are of different sizes than those of the existing form templates. The form types are recognized using algorithms that compare the distances between points that are derived from the centers of identified boxes within the forms. A pre-determined library of points is generated in which many possibilities of the distances are computed, thereby speeding the comparison. Furthermore, a system is described in which there is a set of three stations, a registration station for inputting and confirming new form types, a form identification station, and a form editing station, all connected via a network. However, this patent does not address automated sorting of different form types or distinguishing of different form versions. Additionally, this patent does not address handling forms that do not contain a plurality of boxes or of lines that, because of scan artifacts, hole punches, or other issues, are split into several line segments.

U.S. Pat. No. 5,721,940 (Luther et al., “Form identification and Processing System Using Hierarchical Form Profiles”, Feb. 24,1998) teaches methods for developing a library or dictionary of form templates or profiles using blank forms, comparing the scans of completed forms to the dictionary of form templates, identifying a corresponding form profile, and then having the option to route the scanned form for further processing. This patent teaches methods for extracting data from predesignated fields based on the form identity and then storing the data with the form identity. In addition, this patent teaches a method for displaying the completed form by drawing the identified form using vectorized data from the form dictionary and superimposing the extracted data into data fields. However, this patent does not address situations where a blank form is not available to be used as a template. Furthermore, form profiles are described as a series of blocks or boxes of text or non-text based units, each captured with location and size parameters. Variants of forms are captured as additional blocks or boxes within the form, having different location and size parameters. A drawback to this approach is evident when forms have similar non-text block locations, yet have different input of data, because the forms will not be distinguishable. In.addition, artifacts incurred during scanning processes, either prior to the form identification scanning or at the time of form identification, will cause automated form identification to fail. The inventors recognized several of these shortcomings and suggested a manual identification step as a solution.

U.S. Pat. No. 6,665,839 (Zlotnick, “Method, system, processor and program product for distinguishing between similar forms”, Dec. 16, 2003) teaches a system that is able to identify properties within forms that correspond with properties within other forms and to identify if these properties are the same. This invention is designed to minimize the number of templates that are examined by identifying specific properties that distinguish forms. A further embodiment of this invention includes a coarse stage of identification, wherein the scanned document is transformed into an icon or thumbnail and then compared with a dictionary of icons or thumbnails that represent the dictionary of templates. This initial stage of identification is computationally efficient, using a much smaller data set for each template. Another embodiment of the invention is the definition of reference areas that are unique to a template. The reference areas are used for matching the scanned document to a specific template. However, this patent does not address the identification of form versions where reference areas are similar, yet distinct, or the handling of scan artifacts, overprints or other modifications within the reference areas, and the like.

U.S. Pat. No. 6,950,553 (Deere, “Method and system for searching form features for form identification”, Sept. 27, 2005) teaches a method and system for identifying a target form. Regions are defined on the form relative to corresponding reference points that contain anticipated digitized data from data fields in the form. OCR, ICR, and OMR are used to identify the form template and the resulting strings are compared against the library of templates for matches. A scoring system is employed and a predetermined confidence number is defined. If the confidence number is reached, the template is used for the data capture process. Geographical features can be added for determination. Generally forms are designed to have a top left corner identification field. However, this patent does not address handling of forms for which no template exists, nor provides for identification of form versions where structural text may be highly similar but the placement and relationship of fields to one another differ by form.

U.S. Pat. No. 6,754,385 (Katsuyama, “Ruled Line Extracting Apparatus for Extracting Ruled Line From Normal Document image and Method Thereof”, Jun. 22, 2004) teaches a method and apparatus for removing ruled lines from document images. Additionally, this patent teaches methods for finding straight lines based on information about the size of the standard line pattern. These methods allow the removal of lines from a document, primarily for the later extract information from graphs. However, this patent does not mention using the line detection approaches to match forms, assuming that the user identifies the form to the computer via manual data entry:

U.S. Pat. No. 6,782,144 (Bellavita et al., “Document Scanner, system and method”, Aug. 24, 2004) teaches a method and describes an apparatus that interprets scanned forms. Optical Character Recognition is used to provide data field descriptors and decoded data as a string of characters. The output strings are then checked against a dictionary of forms that have known data descriptors. However, this patent has no mention of line comparisons and requires that image fields be detected by recognition using OCR, ICR, OMR, barcode Recognition (BCR), and special characters. The method of this patent is also limited by the overall accuracy of the OCR, ICR, and BCR.

U.S. Pat. App. Pub. No. US 2003/0210428 (Bevlin et al., “Non-OCR Method for Capture of Computer Filled-In Forms”, Nov. 13, 2003) teaches a method that allows transfer of legacy data to a new database without using Optical Character Recognition. The method includes the translation of the legacy data into a common print format language, such as Adobe PDF. In addition, the application describes a method for manually defining zones on the existing legacy forms that may be used in plurality as templates. However, this application does not mention the use of automated form matching to identify legacy forms.

U.S. Pat. No. 5,293,429 (Pizano et al., “System and method for automatically classifying heterogeneous business forms”, Mar. 8, 1994) teaches a system that classifies images of forms based on a predefined set of templates. The system utilizes pattern recognition techniques for identifying vertical and horizontal line patterns on scanned forms. The identified line segments may be clustered to identify full length lines. The length of the lines in a specific template form may be employed to provide a key value pair for the form in the dictionary. Form identification for the scan using the template dictionary is performed using either a window matching means or a means for comparing the line length and the distance between lines through a condensation of the projection information. In addition, intersections between lines may be identified. A methodology is also taught for the creation of forms with horizontal and vertical lines for testing the system. However, the patent does not teach utilizing other sources of information residing within the forms, such as textual information. In addition, the patent teaches no means for handling scans that do not have an appropriate template within the dictionary. Furthermore, the teaching is limited to a form dictionary that has widely differing form templates; templates that have similar structures, such as form variants, will not be discriminated.

U. S. Pat. No. 7,149,347 (Wnek, “Machine learning of document templates for data extraction”, Dec. 12, 2006) teaches a system that permits machine learning of descriptions of data elements for extraction using Optical Character Recognition of machine-readable documents. The patent teaches methods for measuring contextual attributes such as pixel distance measurements, word distance measurements, word types, and indexing of lines, words, or characters. These contextual attributes and the associated machine readable data are used to provide a generalized description of the document based on the data elements. The generalized description based on the training examples may be developed from a single of a plurality of forms of the same type. Once the description is generated, then novel unknown forms may be tested against the descriptions. Identification of a form type then allows the extraction of data from a scanned image using the predicted location within the training example of data elements. However, the invention does not utilize any structural information within the forms other than the machine-readable text to develop the generalized descriptions. However, the method relies on obtaining a highly accurate level of optical character recognition and the ability to discriminate between actual structural text and input text. This can present a serious problem with forms that have structural text that might be touching lines within the forms, either by design of from lower resolution scanning. Scans that have been skewed during scanning, and scans that are done upside down present serious problems to achieving high levels of optical character recognition. In addition, the inventor does not identify checkboxes and other non-text based input elements.

U.S. Pat. No. 7,142,728 (Wnek, “Method and system for extracting information from a document”, Nov. 28, 2006) teaches a computerized method for extracting information from a series of documents through modeling the document structures, based on identifying lines of text. This teaching is utilized by U.S. Pat. No. 7,149,347, discussed previously, for identifying lines of text and possible groupings into regions.

What has been needed, therefore, is a document analysis system that meets the challenges of entering paper documents via scanning into an electronic system in an efficient manner, capturing and storing the data from those documents in a granular fashion that doesn't limit a user's ability to find needed data and information while keeping whole documents and document groups intact when necessary, providing algorithmic methods that adapt to form variation and evolution, and making the information storage flexible so that later adjustments in search needs may be accommodated. These challenges require a different approach than the ones currently offered. Furthermore, the system should be designed to minimize manual effort, both in the organization of documents prior to scanning, as well as in the required sorting and input of data during the data capture processes.

### SUMMARY

The present invention is a process and set of computer applications that identify document types and versions, locates fields in those documents, and extracts the information from those fields. The information may then optionally be deposited within a database for later data mining, recognition, relationship rules building, and/or searching. In one aspect, the present invention employs a number of processes that automatically detect form type and identify field locations for data extraction.

In particular, the present invention employs several new processes that automatically identify specific form types using form structure analysis, that detect specific fields and extract the data from those fields, and that provide metadata for both fields and documents. These processes increase speed and accuracy, while simultaneously decreasing computation time required for form identification, field location identification, data extraction, and metadata generation. The present invention includes a process and constituent means to achieve that process that minimizes or eliminates manual effort to keystroke input for metadata and identify forms. In one aspect, the present invention employs unique combinations of template definition, line extraction, line matching, OMR, OCR, and rules in order to achieve a high form identification rate and accuracy of alignment for data extraction from specific fields within identified forms.

In one embodiment, the process of the present invention comprises the steps of identifying the form by comparison to a dictionary of template forms, isolating the regions on the form based on position, extracting the images from the regions, depositing the images in a database with positional information, applying recognition if necessary, using rules to validate form identity and correct recognition, and automatically presenting potential errors to a user for quality control. First, templates for forms are established. Next, the documents, pages, or forms to be identified and from which data is to be captured are input. The input scans are then compared against the dictionary of templates in order to identify the type of form. The fields within the identified scans are mapped, and then the data is extracted from the identified fields. Rules for validation and automatic editing of the data have been previously established for each template, and the rules are applied to the data, which is also exported to a database for further validation and editing of the results of the process using quality control system. Finally, field specific business and search rules can be applied, as well as individual recognition activities, in order to convert handwritten input into searchable and computable formats.

In one aspect of the present invention, line identification is used as a foundation for form template set-up, line subtraction, the fingerprinting process, and field identification. The process of line identification involves shaded region identification, line capture and gap filling, line segment clustering, and optional line rotation. Form images or input scans are analyzed to identify shaded regions, and shaded region definitions for the form are stored. Similarly, line segments and corresponding gaps are identified, the gaps are filled to correct for noise and signal loss, and the line segment definitions for the form are stored. The line segments are further clustered into line segments that, through extension, would form a continuous line, but have been segmented because of noise and signal loss. The identified shaded regions are filtered out to ensure that they are not picked. up by the line identification algorithm. The forms are then optionally rotated and the distinguishing parameters for the lines and shaded regions are then stored, linked to the form images, for later use in line subtraction, fingerprinting processes, and/or field identification.

In another aspect of the present invention, two “fingerprinting” methods for comparing line segments found in a scanned form with the line segments defined for the templates contained in the template library are used either singly or in conjunction with each other. These methods compare line position and line length in order to identify the template that most closely resembles the input scan. A first fingerprinting method employs a matching scheme that selects pairs of line segments, one from the template and one from the scan, measures the offset, and then matches the remaining lines between the scan and the template as closely as possible, providing a running score of the goodness of fit using the offset and the template. A second fingerprinting method employs a variety of dynamic programming to align a scan and a form, and then produces a running score as the alignment is tested. If the running score goes above a predetermined level, the algorithm is terminated and the template is not a match. If other templates remain in the library, the process continues with another template from the library. Furthermore, if the score remains below a predetermined level for the duration of the matching process for either method, then the template is considered a match and the identification is made. The fingerprinting methods are incorporated into several processes, including identification of line segments for an input scan, identification of the template that best matches the input scan, clustering of input scans that do not have matching templates, and, where necessary, quality control and utilization of OCR and OMR for form identification.

In another aspect of the present invention, new form templates may be automatically defined. In a preferred embodiment, a template for a new form type is defined by identifying the lines, boxes, or shaded regions located within the form instance and determining a location and size for each identified line, box, or shaded region. From the location and size determined for the lines, boxes, or shaded regions, form fields having an associated form field location are defined, any text within each defined form field is recognized and, based on the text content and the form field location, a form field identifier and a form field content descriptor is assigned. The line locations, form field identifiers, associated form field locations, and associated form field content descriptors are then stored to define a form template for the new form type. Identified fields are usually provided with metadata, such as the name of the field and the type of data expected within the field, as well as, optionally, other information, such as whether or not the field has specific security or access levels. If necessary, clean up is performed, removing extraneous marks, writing, or background, extending and straightening lines through scanning gaps, removing stains and spurious content that crosses lines, shaded region removal, and despeckling.

In a further aspect of the present invention, identification of forms that are missing from the template set is facilitated by a process that determines which unidentified scans may be represented a plurality of times within a large set of scans undergoing identification, as well as providing information about the form type and name. Forms that have undergone fingerprinting and ended up as null hits are marked as such and stored. When the number of null hits reaches a critical number, then each null hit is fingerprinted against the other null hits. Any scans that then have matches with other scans are placed in a cluster based on the line segments that are identified using the fingerprinting process. A user may optionally choose to visually inspect the clusters and proceed to either locate a potential form template from another source or to generate a template using one or more of the scans within the cluster, or the scans within a cluster may then undergo partial or full form recognition to provide a string of recognized characters. Character strings from the scans within a cluster are then compared using a variety of algorithms to identify similarities that can be used to identify or create a new form template.

### BRIEF DESCRIPTION OF THE DRAWINGS

Other aspects, advantages and novel features of the invention will become more apparent from the following detailed description of the invention when considered in conjunction with the accompanying drawings wherein:

FIG. 1 is a representation of a tree structure for the standard document model;

FIG. 2 is an embodiment of the top-level flow of a forms processing system according to one aspect of the present invention;

FIG. 3 is a flowchart of an embodiment of the process for generating templates and template definitions according to one aspect of the present invention;

FIG. 4 is a flowchart depicting the steps in identifying the lines within a form according to one aspect of the present invention;

FIG. 5 is a schematic depicting the treatment of an exemplary shaded region;

FIG. 6 depicts examples of line segment identification and clustering according to one aspect of the present invention;

FIG. 7 depicts an example of the process of defining the angle of a horizontal line according to one aspect of the present invention;

FIG. 8 is a flowchart of an embodiment of a semi-automated process for defining a template form according to one aspect of the present invention;

FIG. 9 is a flowchart of an embodiment of a fully automated process for defining a template form according to another aspect of the present invention;

FIG. 10 is a flowchart showing exemplary steps in inputting filled-in forms into the database according to one aspect of the present invention;

FIG. 11 is a flowchart of an embodiment of a method for fingerprinting according to one aspect of the present invention;

FIG. 12 depicts hypothetical examples of a scan and four templates;

FIG. 13 depicts diagrammatically an example of determination of offset during the fingerprinting process according to an aspect of the present invention;

FIG. 14 depicts two exemplary mappings of a scan to different templates according to one aspect of the present invention;

FIG. 15 is a flowchart for an embodiment of a method for fingerprinting using dynamic programming according to one aspect of the present invention;

FIG. 16 depicts an exemplary dynamic programming matrix for fingerprinting according to the embodiment of FIG. 15;

FIG. 17 is a flowchart of an embodiment of a process for using Positive Identification Scores, False Identification Scores and Template Indexing according to one aspect of the present invention;

FIG. 18 is flowchart for an embodiment of a process for extracting images from fields on a scanned page according to one aspect of the present invention;

FIG. 19 depicts two examples of mark field inputs according to one aspect of the present invention;

FIG. 20 depicts exemplary results of OMR analysis from seven form types;

FIG. 21 depicts the same regions for two exemplary close form versions;

FIG. 22 is a flowchart for an embodiment of the process of clustering unidentified scans and identifying properties useful for identifying the proper template for a cluster according to one aspect of the present invention; and

FIG. 23 is a flowchart for an embodiment of the process of generating a set of “aged” scans for testing Fingerprinting and other recognition methods according to one aspect of the present invention.

### DETAILED DESCRIPTION

The present invention is a process for capturing data from forms, both paper and electronic. In one embodiment, the process of the present invention comprises the steps of identifying the form by comparison to a dictionary of template forms, isolating the regions on the form based on position, extracting the images from the regions, depositing the images in a database with positional information, applying field specific recognition if desired or necessary, using rules to validate form identity and correct recognition, and automatically presenting potential errors to a user for quality control. The present invention also describes the enabling technology that allows any and all form data to be repurposed into other applications.

As used herein, the following terms are to be interpreted as follows:

“Scan” means an electronic document, generally a scanned document, preferably a single page. Scans are unidentified when the process is initialized and are identified through an aspect of the present invention. A scan may further be an image of a page, in TIF, JPEG, PDF, or other image format.

“Form” and “form instance” means any structured or semi-structured document. A form may be a single page or multiple pages.

“Template” means any form, page, or document that has been analyzed and stored for comparison against scans. Scans are identified by comparing their specific characteristics, such as, for example, line location and length or text content against the templates. A dictionary of templates comprises a set of templates. Template dictionaries may be used in a plurality of workflows, or may be restricted to a single workflow.

“Template ordering” means prioritizing templates according to the likelihood that they are a match to a particular unidentified scan.

“Fingerprinting” and “to fingerprint” mean automated scan identification methods by which unidentified scans are compared with known template forms, ultimately yielding either a best match with a specific template or a “null result”, which means that none of the templates match sufficiently well to the unidentified scan of interest to be considered a match. Fingerprinting utilizes the line locations on the unidentified scan and compares those lines to the plurality of the lines comprising the templates.

“False Identification Score (FID)” means the score during Fingerprinting above which there is no possibility that a form instance alignment matches the template alignment. The FID is used to minimize the number of alignments that are fully checked during the Fingerprinting of each template offset against the scan.

“Positive Identification Score (PID)” means the score during Fingerprinting below which a correct template hit is indicated, meaning that the scan has been matched to the correct template. The Fingerprinting for that scan is finished, as the continuation of Fingerprinting against other templates will not yield a better (lower) score. There are several levels of PIDs, including a template specific PID, a global PID, and a PID group PID.

“Cluster UIS” and “Unidentified Scan Clustering” mean a process that determines which unidentified scans may be represented a plurality of times within a large set of scans undergoing identification, as well as providing information about the form type and name.

“Optical Character Recognition (OCR)” means a computerized means for recognizing text within an image.

“OCR anchors” means regions or fields of a scan that are examined with OCR technology and then compared with the same regions or fields of a template to validate fingerprinting results.

“Optical Mark Recognition (OMR)” means a computerized means for recognizing whether a checkbox, circle, mark field or the like has be filled in or left empty. OMR generally represents a Boolean output—either filled in or empty.

“Mark field” means a type of field consisting of check boxes, fill-in circles, radio buttons, and similar devices. These fields are a special class within a form that take binary or Boolean answers, Yes/No, True/False, based on whether the user has checked or filled in the field with a mark. The mark fields are analyzed using Optical Mark Recognition.

“Mark field groups” and “mark field rules”. When mark fields are related within a form or a plurality of forms, such as instances of two mark fields representing the “Yes” and “No” for the same question, these related mark fields may be clustered into groups. Mark field groups may be further clustered, if also related. Mark field rules are the rules that bind mark fields into groups. For example, in the Mark field group that contains a Yes and No mark field, only one of the fields may be positively marked.

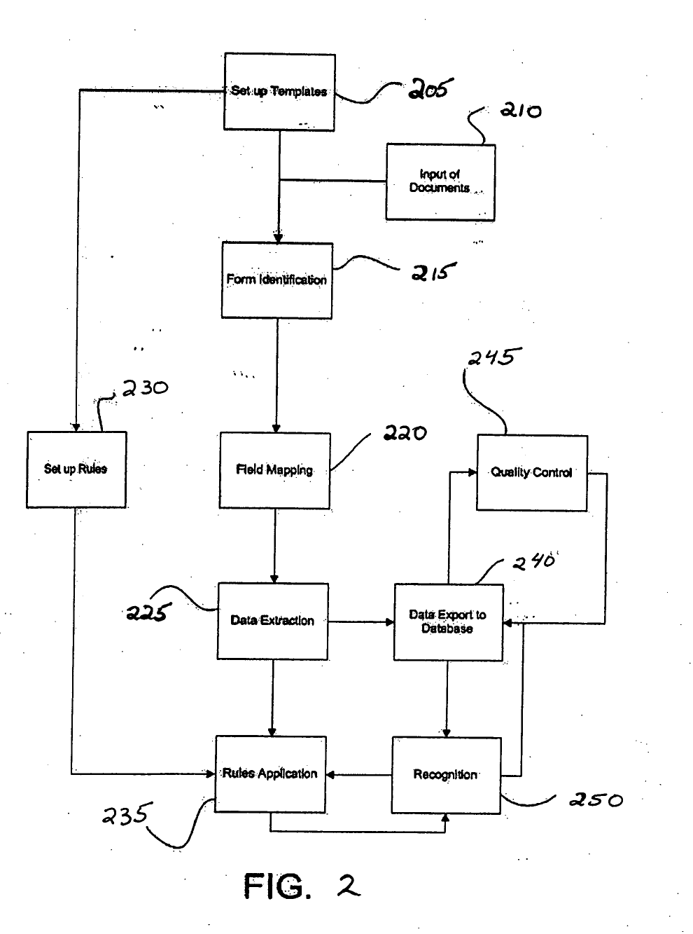

A flowchart overview of an embodiment of the process of the present invention is shown in FIG. 2. In FIG., 2, templates for forms are established 205. Next, the input scans—documents, pages, or forms to be identified and from which data is to be captured—are input 210. Examples of these may include, but are not limited to, scanned documents, pages, and forms, and electronic copies of existing images, such as TIF, JPEG, and PDF format files, all of which are defined as “scans” within the description of the present invention. The input scans are then “Fingerprinted”, i.e. compared against the dictionary of templates, in order to identify the type of form 215. The fields within the identified scans are mapped 220, and then the data is extracted 225 from the identified fields. Data extraction 225 to obtain meaningful data from the images within the fields may be accomplished using any of the many recognition algorithms 250 known in the art including, but not limited to, Image Recognition, Optical Character Recognition, Optical Mark Recognition, Intelligent Character Recognition, and Handwriting Recognition. Rules for validation and automatic editing of the data have been previously established 230 for each template, and the rules are applied 235 to the data, which is also exported 240 to a database for further validation and editing of the results of the process using quality control system 245. Finally, field specific business and search rules can be applied as well as individual recognition activities 250 in order to convert text and handwritten input into searchable and computable formats.

Template selection and cleanup. In one aspect of the present invention, templates are developed or set-up (step 205 of FIG. 2) from a number of existing sources, including existing blank paper forms after scanning, electronic versions of blank forms, and filled-in paper or electronic forms. The templates developed from existing filled-in paper or electronic forms may optionally be cleaned up, if needed, by the use of any open source or commercially available image manipulation program known in the art, such as, but not limited to, GIMP or Adobe Photoshop, in order to remove data and images from the forms, thus permitting the process to recognize the structural lines of the forms. Furthermore, especially with scanned in forms, blank or filled in, scanning artifacts, such as slant, or skew, may be removed or adjusted using the image manipulation programs.

Once the forms designated to be used as templates are of sufficiently high quality, each line within a form is identified and cataloged. The line identification is an automatic process comprised of locating contiguous pixels that comprise a straight line, extending those lines, filling in gaps as appropriate, clustering line segments, and straightening and rotating the lines as needed. The lines make up the line scaffold for the template. The line identification is also used on incoming forms as well, in order to produce the line scaffold that corresponds to the set of lines for each form.

Template definition. In another aspect of the present invention, there are manual, automated or semi-automated methods for identifying fields within templates. The manual method generates the location of the field within the template using a specifically designed user interface that allows the user to rapidly draw rectangles around fields in the template using a mouse or keystrokes or a combination of both. The automated method comprises automatically finding lines that form boxes and noting the location of those boxes. The semi-automated method generally uses the automated method to first identify a number of boxes and then the manual method to refine and add to the automatically found boxes. In addition, those identified fields are provided with metadata, including, but not limited to the name of the field, the type of data expected within the field, such as-a mark, text, handwriting or an image, and, optionally, other information, such as whether or not the field has specific security or access levels.

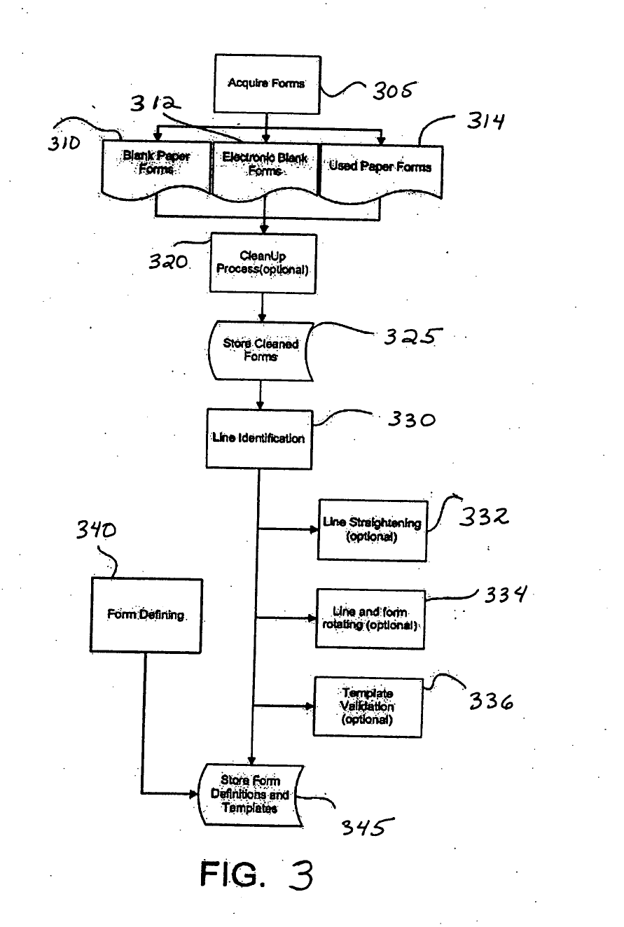

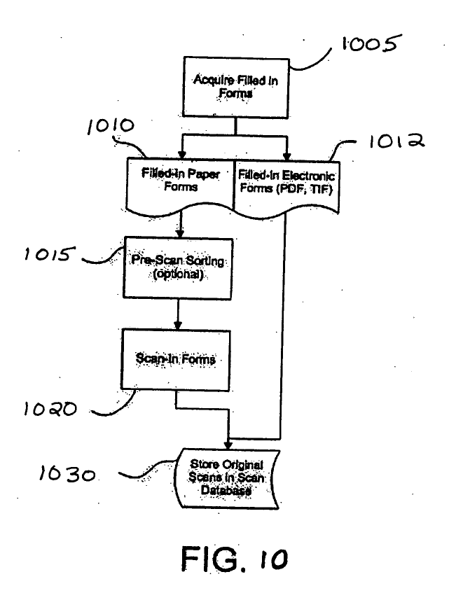

FIG. 3 is a flowchart of an embodiment of the process for generating templates and template definitions according to one aspect of the present invention. In FIG. 3, needed forms are acquired 305 in-electronic format, including blank paper forms 310, electronic blank forms 312, and used paper forms 314, the paper forms being scanned to transform them into electronic versions or scans, preferably at 300 dpi or greater. This process is similar to that used to acquire electronic copies of the unidentified forms of interest, as discussed in conjunction with in FIG. 10. If necessary, clean up 320 is performed, removing extraneous marks, writing, or background and straightening lines. Generally, clean up 320 is only necessary when using filled-in forms due to the lack of either an electronic or paper blank form. As understood by any one skilled in the art, clean up 320 may use any open source or commercially available image manipulation program, such as GIMP or Adobe Photoshop, in order to remove data and images from the forms and thereby permit the process to recognize the structural lines of the forms. Furthermore, structural lines of the forms that are destined to be templates may be straightened and adjusted using the same programs. Often, scanning, especially of previously scanned documents or old and soiled documents, requires substantial efforts to generate good templates. The clean up of scans prior to templatizing may be done automatically, using any of the many programs known in the art, such as, but not limited to, Kofax Virtual Rescan, or manually, using programs such as Adobe Photoshop or GIMP.

Generally, clean up step 320 includes extending and straightening lines through scanning gaps, removing stains and spurious content that crosses lines, and despeckling. Automated clean-up processes include shaded region removal and despeckling. For example, if the template document is based on a scan of an old document, or a previously scanned or faxed document, judicious use of a shaded region removal algorithm, may result in construction of an enhanced template. Furthermore, scanned forms may be enhanced by the same means to increase form identification and data extraction accuracy. The removal of shaded regions is important in that they may have some characteristics similar to lines, and therefore affect both line segment detection and provide ambiguity in fingerprinting.

The forms readied for use as templates are then stored 325 as digital images in any variety of formats, including, but not limited to PDF, TIF, JPEG, BMP, and PNG. Generally these digital copies are stored in grey scale or Black and White versions, but they also may be stored in other modes. In the preferred embodiment, the images are stored as black and white images. Line identification 330 is performed next, optionally including line straightening 332, line and form rotating 334, and/or template validation 336. Finally, the forms are defined 340 and the form definitions and templates are stored 345.

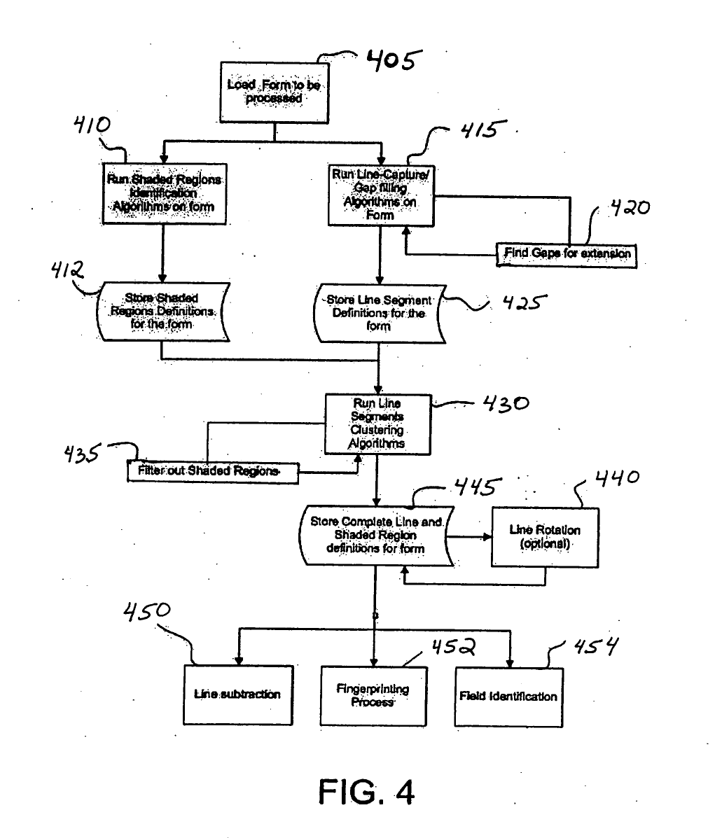

Line Identification (step 330 of FIG. 3). A major sub process that is used as a foundation for the template set-up, line subtraction, the fingerprinting process, and the field identification, is the generation of the line scaffolds from the forms. This process involves shaded region identification, line capture and gap filling, line segment clustering, and line rotation. FIG. 4 is a flowchart depicting the steps in identifying the lines within a form, according to one aspect of the present invention.

As shown in FIG. 4, the form to be processed is loaded 405, which requires an electronic copy, either derived as the output from a scan, preferably at 300 dpi or greater, or from an existing electronic copy, such as a TIF, PDF, or other image format file, again with sufficient resolution to allow correct analysis (generally 300 dpi or greater). If necessary, the form images or scans are then analyzed using algorithms that identify shaded regions 410, and the shaded region definitions for the form are optionally stored 412. Similarly, line segments 415, and corresponding gaps 420 are identified, the gaps are filled to correct for noise and signal loss, such as from folds and creases in the paper, stains, photocopy, and scan artifacts, and the line segment definitions for the form are stored 425. Next, the line segments are clustered 430. The line segment clusters consist of single pixel wide line segments that, through combination, would form a continuous line. The identified shaded regions are filtered out 435 to ensure that they are not picked up by the line identification algorithm. The forms are then optionally rotated 440 as determined using the average of the angles of the lines to the horizontal and the vertical axes of the forms and the distinguishing parameters for the lines and shaded regions are then stored 445 in a database, linked to the form images, for later use in line subtraction 450, fingerprinting processes 452, and/or field identification 454.

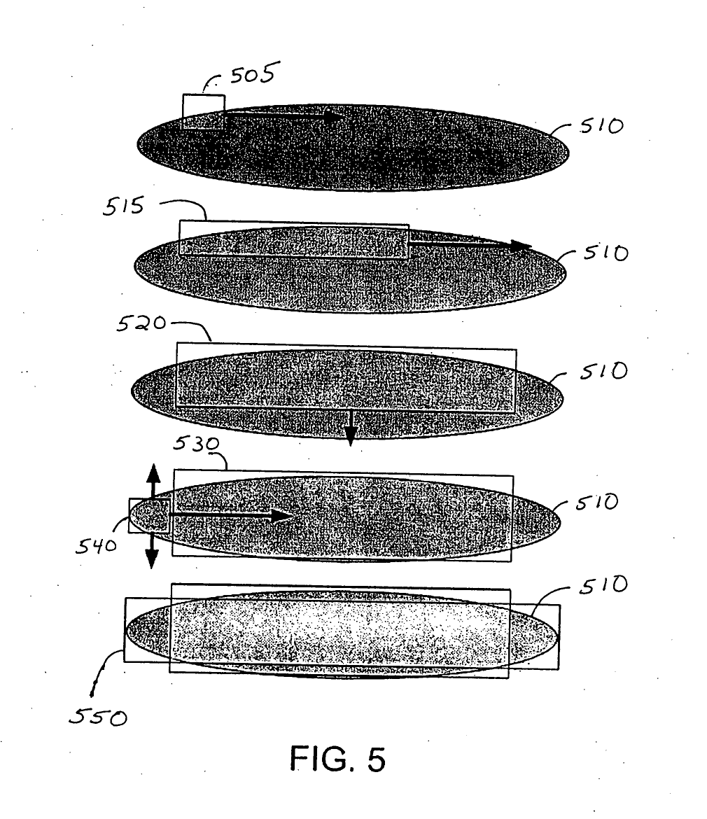

In a preferred embodiment, an initial step taken during line identification (FIG. 4) is to identify and filter. out shaded regions (FIG. 4, steps 410 and 435), as graphically illustrated in FIG. 5, which is a schematic depicting the treatment of an exemplary shaded region. This process comprises analyzing pixel density to find areas on the document with a high filled-in density over a swath wider than the lines found in the document—generally greater than 10 pixels. The swath does not need to be regularly shaped. In the preferred embodiment, the settings that work well have the algorithm looking for sequential square areas with greater than 45% of the pixels being filled in. However, depending upon the image, the level of pixels filled in may range from under 10% for removal of a background stain, to greater than 75% when trying to remove very dark cross outs from pages with pictures. This method functions by means of looking at non-overlapping squares of pixels in the image.

With reference to FIG. 5, if square 505 imposed over area 510 is found to consist of 45% or more filled in pixels, the algorithm then starts expanding the square 515, 520, 530. The expansion extends the border of the square by extending out each edge by a single pixel, ensuring that the newly added region also contains 45% or more filled in pixels. This is repeated (see box 540) until the shaded area is completely identified, the end result being a set of rectangular regions 530, 550 covering shaded region 510. By digitally filtering or removing the areas found by this algorithm, the line identification process is not confused by shaded regions. In addition, since those regions are captured to the database, removal of the shaded regions electronically from the form is possible. Furthermore, by adjusting the shaded region identification algorithm, one can selectively find (and therefore remove or manipulate) different sizes and shapes of shaded regions. For example, block shaded regions may be specific to a form type, and thereby may be used in form identification, whereas cross out of data using magic marker or sharpie marker most likely will be specific to the page. In addition, the process may be used reiteratively before and after line identification, with the first set of shaded areas removed using a large swath width and then, after lines are identified, the swath width may be readjusted to a narrower width, allowing capture of more shaded regions.

The identification of shaded areas with black pixel densities greater than X % (X being 10 to greater than 75) consists of:
Sequentially test non-overlapping regions of the image.
   If the region is >X % black pixels,
      expand by one pixel in −Y direction if new region >X % black pixels,
      expand by one pixel in +Y direction if new region >X % black pixels,
      expand by one pixel in −X direction if new region >X % black pixels,
      expand by one pixel in +X direction if new region >X % black pixels,
   repeat until no more expansion occurs.
For each previously found region,
   If new region overlaps by 50% or more,
      Store composite region that contains both regions.

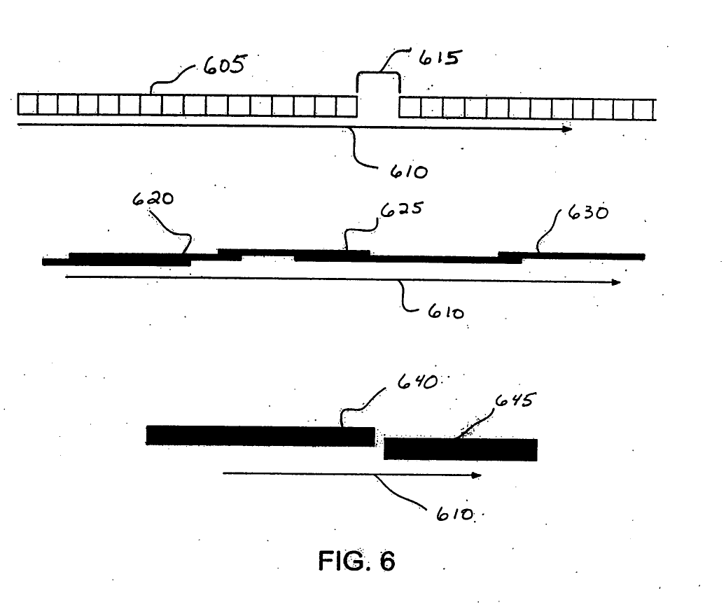

The digital images are then processed to find all straight lines greater than a specified length. The same process is used to identify unknown forms prior to the fingerprinting process. Lines are identified using a set of algorithms consisting of an algorithm that identifies line segments (FIG. 4, step 415), a line segment clustering algorithm (FIG. 4, step 430), and a gap filling algorithm (FIG. 4, step 420). FIG. 6 depicts examples of line segment identification and clustering according to one aspect of the present invention.

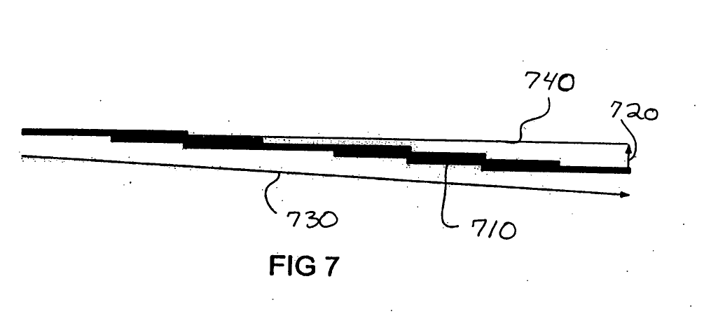

As illustrated in FIG. 6, when a filled pixel 605 is found, the segment identifying algorithm counts all the adjacent filled pixels in the x or y direction 610. When the algorithm encounters blank pixel 615, the gap filling algorithm checks to see if there are any filled pixels on the same line in the x or y direction 610 within an extension length (generally 3-5 pixels). Then, as discussed in conjunction with FIG. 7, any line segments 620, 625, 630 that may be shifted in the perpendicular to the general direction of the found line segment by a shift length (generally 1 pixel). The density of shifting, as defined by the length of a cluster versus the number of shifts required, and the lower bound on line length may be adjusted, thereby allowing both straight and curved lines to be distinguished. In the preferred embodiment for form identification, the shift density is kept small and the minimum line segment length is kept high in order to distinguish straight line segments.

After all the line segments in both the x and y directions are identified, the line segment clustering algorithm is used to join line segments into contiguous line clusters. As shown in FIG. 6, line segments 640, 645 that overlap are clustered. A minimum length is then described for a cluster, with any line clusters below a defined length being discarded. The clusters are stored in the database and annotated with their locations on the forms, along with structural information such as width, center point and length. The line detection methodology employed in the present invention further includes detection of butt end joins, when line segments are shifted vertically within the specified number of pixels but do not overlap.

FIG. 7 illustrates line and form rotation determination schematically. In FIG. 7, line clusters 710 are analyzed for their respective angle in the x or y direction 730 to the horizontal 740 (or vertical in the case of vertical lines). Conceptually, the angle is determined by analyzing the delta Y 720 from the start of the line cluster to its end and its length using the following standard geometric relationship—tan(angle)=opposite/adjacent. The algorithm uses atan(ratio) where ratio is (change in Y)/(change in X) for horizontal lines, and the inverse for vertical lines. The average angle for the clusters on the page or scan is calculated and the line clusters are then rotated by that angle to the horizontal. The same manipulations may be performed using the vertical lines for verification or as the main computation to identify the rotational angles.

Field Definition. The defining of bounded areas or fields (FIG. 2, step 220) has been previously disclosed in co-pending U.S. Pat. App. Ser. No. 11/180,008, filed Jul. 12, 2005, entitled “Forms-Based Computer Interface”, which is herein incorporated by reference in its entirety. Briefly, a method is disclosed that provides means to indicate and capture the locations of bounded areas on documents that are entered to the system in a variety of ways, including scanning, as electronic copies, and direct building using form generating programs, such as Microsoft Word, Visio, and the like. In one embodiment disclosed in the application, the user manually enters the boundaries of fields on the template forms using mouse or cursor movements, direct input of x and y positions, or a combination of both entry mechanisms. In addition, if so desired, the user may add information about the fields, such as, but not limited to, the name of the field, its presumed contents data type (e.g. text, handwriting, mark, image), a content lexicon or dictionary that limits the potential input data, and intra and inter-field validation and relationship rules. The resulting defined fields and parent forms are then stored in a database as a defined template.

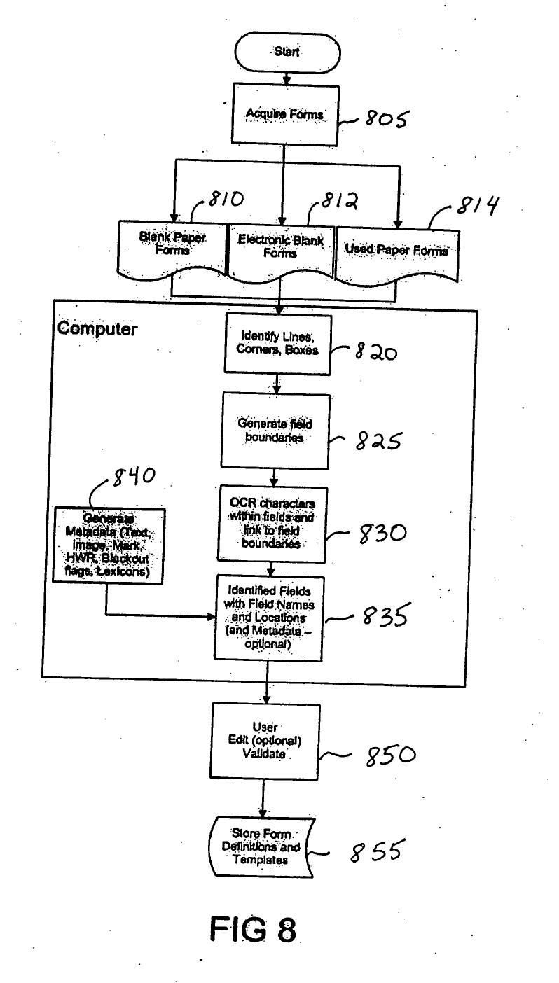

FIG. 8 is a flowchart of an aspect of an embodiment of the present invention that extends the manual approaches previously used to define the fields within forms into an automated process or processes. A key step in indexing, identifying and extracting data from structured forms is the accuracy, effort, and speed at which template forms can be accurately defined and placed in a template dictionary. In the currently preferred embodiment, a great deal of the form definition process is automated. The process includes automating the location of field positions based on lines and intersections as determined using the line identification process and determining intersection points, the process of generating boxes around the field positions, recognizing and storing the character strings from within those fields, transferring those character strings to the metadata associated with the fields as appropriate, and storing the positions of the fields and the related character strings for an optional user quality control and editing step. At any point in the process, manual input may be used to enhance the accuracy of the form definition. In particular, the automation of determining boxes and field locations reduces the small errors associated with a manual process of spatially defining the fields.

As shown in FIG. 8, after the needed forms are acquired 805 in electronic format from blank paper forms 810, electronic blank forms 812, and/or used paper forms 814, field positions are located 820 based on the identification of lines, corners, and boxes. Next, field boundaries are generated 825. Character strings from within those fields are recognized 830 and linked to the field boundaries, then the fields are identified 835 with field names and locations and optionally linked to metadata 840 associated with the fields. The positions of the fields and the related character strings may be edited and validated during an optional user quality control and editing step 850, after which the form definitions and templates are stored 855.

The automatic generation of templates for use in a visualization and editing environment consists of a set of computerized steps that utilize sub-processes from Fingerprinting and OCR analysis. These sub processes are coupled together to provide highly defined templates, generally saving considerable time and effort in the template generation phase of the whole form identification process. In particular, lines are detected using the line identification process and another algorithm is used to find intersections, which are then automatically analyzed to determine field boundaries or boxes. The field boundary determination consists of the following steps:
1. Extract all intersection points and line endpoints.
2. Sort points in increasing X then Y values.
3. Generate boxes:
   3a. for each point P1,
      3a1. for each point P2 where P2.X>P1.X and P2.Y=P1.Y;
      3a2. for each point P3 where P3.Y>P2.Y and P3.X=P2.X; and
      3a3. if point P4 exists where P4.X=P1.X and P4.Y=P3.Y
   3b. Create a box using P1, P2, P3, P4.
4. For each box found:
   4a. if Box B1 contains any other box, remove box B1 from the list. This reduces the number of concentric boxes that share a single or a plurality of sides.

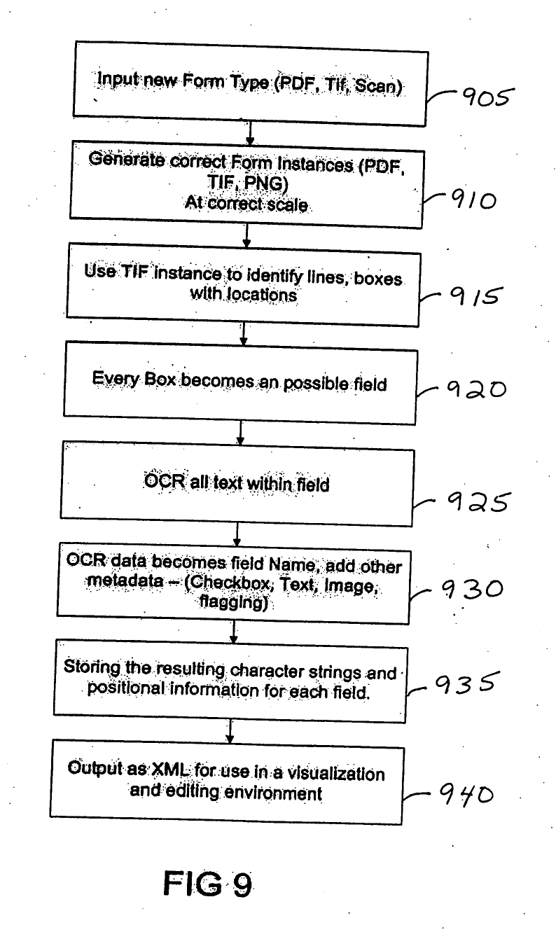

FIG. 9 is a flowchart of an embodiment of a fully automated process for defining a template form according to another aspect of the present invention. As shown in FIG. 9, a new form type is input 905 and correct form instances are generated 910 at the correct scale. Lines and boxes are identified with their locations 915, and each identified box is further identified as being a possible field 920. Text within fields is recognized 925, using OCR or other methodologies, the data obtained is assigned as the field name or identifier 930, and other metadata, such as identification of the field as a checkbox, text field, image field, or flagging field, is added as required. The resulting character strings and positional information for each field are stored 935, and the form is output in a format (such as, but not limited to, XML) for use in a visualization and editing utility 940.

In a further embodiment of the present invention, an existing template definition is used to provide field definitions and positional information for a new form template, such as a new version of the same form. In this embodiment, lines that match closely between the existing and new templates are considered the same. Lines are used to construct boxes in both the existing and new templates, which are then mapped using the line matching information. Field positions and boundaries may be matched to the boxes in the existing template within a defined tolerance. Fields in the new template that are derived from mapped boxes are eligible for transfer of metadata, including names and data types, from fields in the existing template. The new template may then be checked using OCR and comparisons of strings provides an assessment of accuracy. Furthermore, the new template definition may be edited manually and then the new field positions and metadata is stored to the database as a newly-defined template.

Once the template setup is complete, the filled-in forms are input for data capture (step 210 of FIG. 2). FIG. 10 is a flowchart showing exemplary steps in inputting filled-in forms into the database, according to one aspect of the present invention. In FIG. 10, filled-in forms are acquired 1005 from filled-in paper forms 1010 and/or filled in electronic forms 1012. The acquired paper forms 1010 may optionally be subject to pre-scan sorting 1015 before being scanned 1020 into electronic format. The scanned and/or electronic forms are then stored 1030 in a database to await processing. It will be clear to one of ordinary skill in the art that these are exemplary steps only, and that any of the other methods known in the art for electronically acquiring forms may be employed in the present invention.

Optional pre-identification processing. In one aspect of the present invention, automated scan processing may be employed to remove speckling and background noise, to delete large marks on the page that may interfere with alignment, remove short lines (as defmed by the user), and to remove single pixel-wide lines.

Form identification (step 215 of FIG. 2). In another aspect of the present invention, automated scan identification methods by which unidentified scans to be recognized are compared with known template forms are employed, ultimately yielding either a best match with a specific template or a “null result”, which means that none of the templates match sufficiently well to the unidentified scan of interest to be considered a match. This method, referred to herein as “Fingerprinting”, utilizes the line locations on the unidentified scan and compares those lines to the plurality of the lines comprising the templates. During the Fingerprinting process, scaling factors are determined and translation of the form relative to the template is tested in both X and Y directions. Each unidentified scan may be Fingerprinted against each template form, yielding a comparison score. The score relates to the closeness of match of the unidentified scan with the template form. The template that yields the best.score may be declared a match. Alternatively, if a suitable score is not reached, then the unidentified form is considered not to have a corresponding template within the template dictionary. In identification projects where the template set is incomplete, or where novel forms are represented in the scan set, another aspect of the invention provides for methods that cluster those similar scans that do not have appropriate templates. The clusters of unidentified scans are then further analyzed to help the end user identify distinguishing properties of the scans that may be used to find or select appropriate templates from external sources. In addition, a single or a plurality of scans may be used to generate the needed templates.

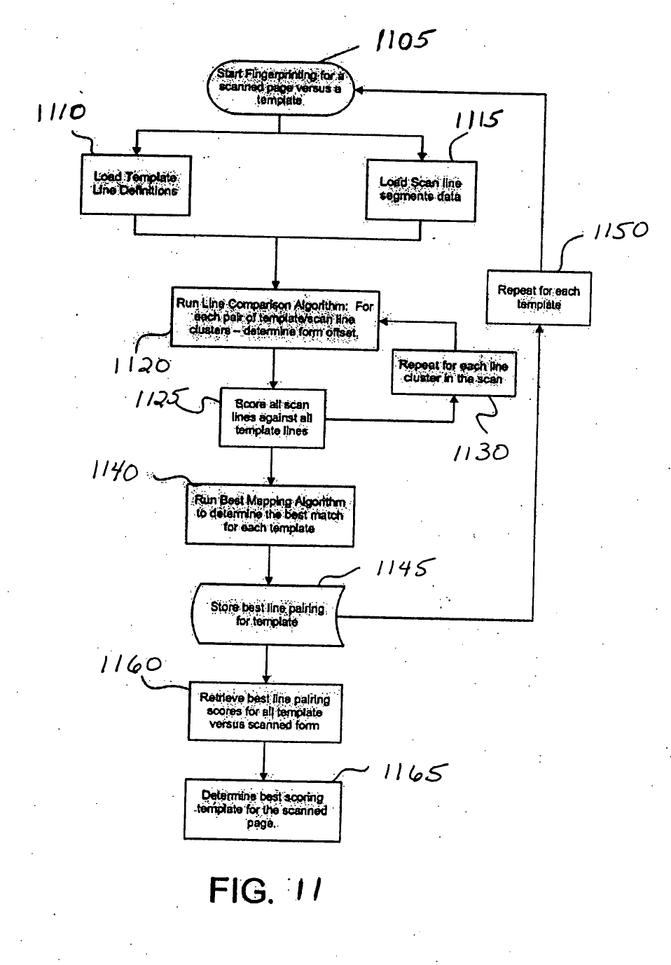

Fingerprinting Method 1. In a preferred embodiment, the unidentified scans are identified automatically as part of the total data extraction process. The process accomplishes this by comparing the line cluster locations and lengths between the scans and the templates, and then determining which template best matches the scanned page. FIG. 11 is a flowchart of the steps during form identification, herein described as Fingerprinting.

As shown in FIG. 11, the process of Fingerprinting may be broken down into several sub-processes, each of which may be optimized using techniques available to those skilled in the art of software development, such as caching of appropriate data, lessening the time required to access the data, and using multi-threading to increase the efficiency during use of multi-processor systems. After initialization 1105 of the process for a scanned page versus a particular template, the template line definitions 1110 and the scan line segments data 1115 are respectively loaded. The next sub process is comprised of a major iterative loop that stores the data for each template comparison with the scan and a subloop that iteratively runs the line comparison for each reasonable initial line pairing within the scan and the template. In this sub process, the line comparison algorithm is executed 1120 for each pair of template/scan line clusters to determine the form offset, if any, and all scan lines are scored against all template lines 1125. This process is repeated 1130 for each line cluster in the scan. Next, the result of the scoring for the best line matching for each offset is compared for the template, the best template match is determined 1140, and the best line pairing for the template is stored 1145. The entire process repeats 1150 until all templates have been evaluated against the scanned page. As the major loop progresses, the best match is maintained and, if a suitable match is found, the match is returned 1160 when the loop completes and may be used to determine 1165 the best scoring template for the scanned page.

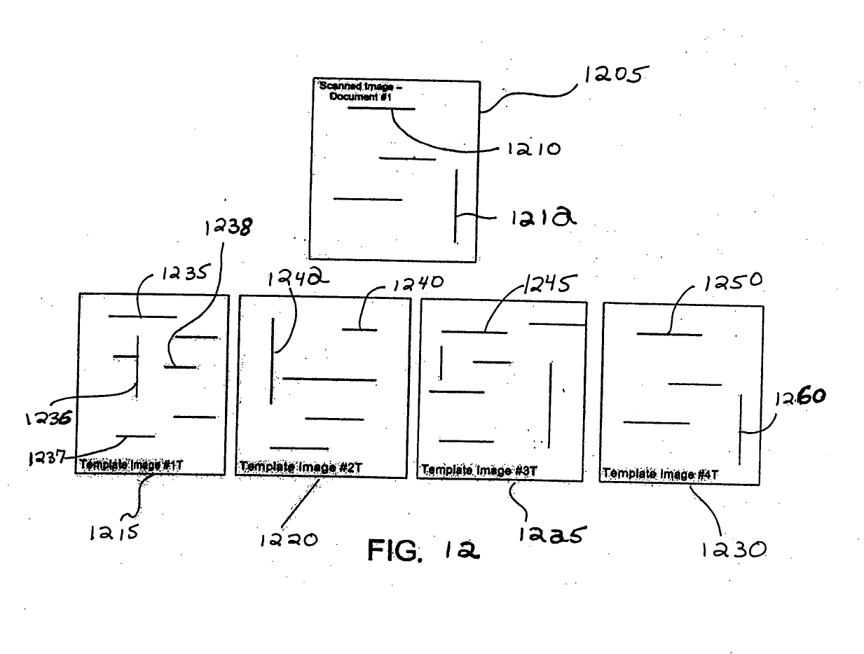

An example application of the fingerprinting process is as follows:
1. Extract the line definitions for a scan from the Line identification process (FIG. 11, element 1115). FIG. 12 depicts an exemplary graphical representation of a scanned image 1205, showing scanned lines 1210, 1212. The position and length of lines 1210, 1212 are used for the scan line definition.
2. Load the line definition for a template from the Line identification process (FIG. 11, element 1110). FIG. 12 also depicts exemplary graphical representations of four templates (Template Images # 1T 1215, 2T 1220, 3T 1225, and 4T 1230). The position and length of template lines 1235, 1236, 1237, 1238, 1240, 1242, 1245, 1250 are used for the template line definitions.
3. A subset of lines and line pairs are allowed for determining the offset space.

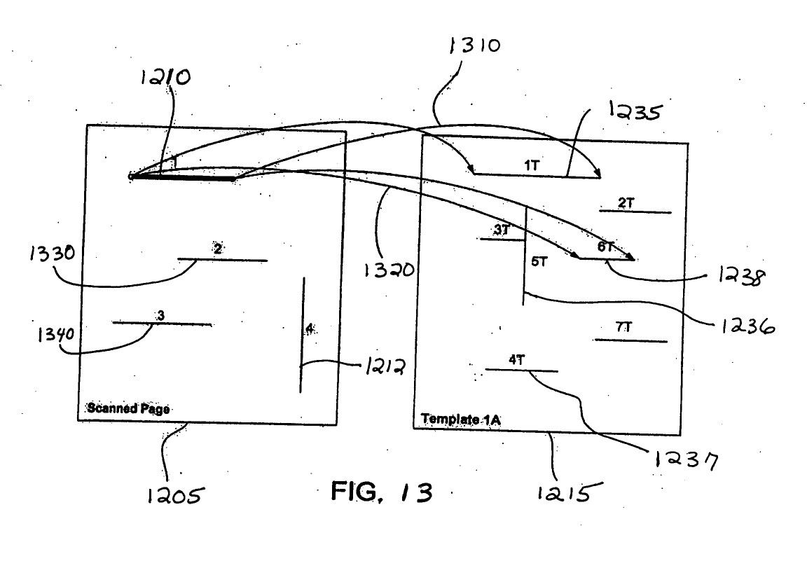

Lines that are short, line pairs that are not within an allowable scaling factor, and line pairs that would yield a high scan/template offset are disallowed. For each pair of allowed line segments (one line segment from the scanned page and one line segment from the template):
a. Determine the form offset and form scaling factor. FIG. 13 depicts diagrammatically an example of determination of offset during the fingerprinting process according to an aspect of the present invention. In FIG. 13, scan 1205 line 1 1210 is compared against the horizontal lines 1235, 1238 in template #1A 1215. Each mapped pair (line 1 1210 and line 1T 1235 represents a pair, and line 1 1210 and line 6T 1238 represents another pair) results in an offset based on the change in position of each endpoint. Hence form offset 1310 for scan line 1 1210 to template line 1T 1235 is relatively small, both in the x (small shift to the right) and y (slight shift up) directions as compared with offset 1320 for scan line 1 1210 to template line 6T 1238 (a small shift to the right in the x direction and a large shift down for the y direction). Pairing between scan line 1 1210 and template #1A 1215 line 1237 would be disallowed due to a high scan template offset.
b. For each form offset and scaling factor, score all scan lines against all template lines using properties such as distance between matching line endpoints or line length differences. Using form offset 1310 shown for line pair 1 1210 and 1T 1235 in FIG. 13, line 2 1330 would be matched to its closest potential match, line 6T 1238 in Template 1A 1215, line 3 1340 would most likely be matched to 4T 1237 and line 4 1212 would be matched to the only vertical line, 5T 1236.
c. Generate the best overall alignment by choosing the best scoring form offset and scaling factor until all template or scan lines have been chosen a single time.
d. For some poorly scanned images, form lines can be detected as a set of partial lines. In this case, the method can be extended to generate partial template lines based on the match to a line fragment in the scan lines. These partial template lines can then be matched against the unmatched scan cluster fragments to further complete the alignment.
4. Store the best Line pairings and the resulting form offset generating the lowest score for the template. A score represents a weighted sum of the differences between line locations and line lengths for the best pairwise matches on the scan to the template. In addition, penalties are added for lines that appear in the scan and not in the template and visa-versa.
5. Repeat steps 2-4 for each template.
6. Determine the best template for the scanned page by comparison of the scores.

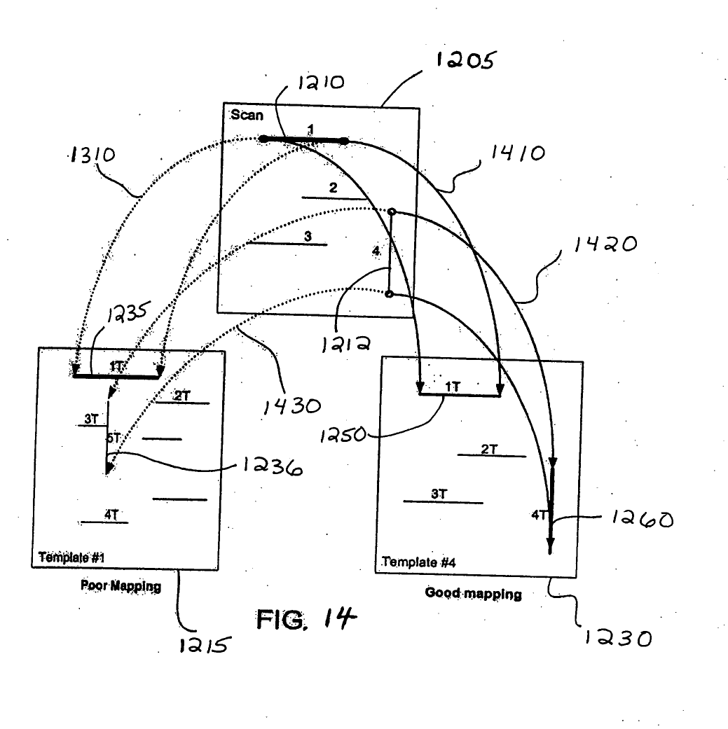

FIG. 14 presents a graphical representation of the mappings of two sets of line pairs, one horizontal and one vertical, for scan 1205 against each of two templates 1215, 1230. In FIG. 14, the optimal form offsets 1310, 1410 were generated using line 1 1210 of scan 1205 and lines 1T 1235, 1250 of templates 1215, 1230. When the vertical lines 1212, 1236, 1260 are considered, however, offset 1420 for template #4 1230 is better than offset 1430 for template #1 1215. Extrapolating the line pairings through the complete set using the offset, Template #4 1230 achieves a lower overall score, and hence is determined to be the better match for these two templates. This approach is continued for all the templates in the template dictionary.

In this manner, the process does not depend upon initially selecting the correct match for a line pairing between the scanned page and the template to start the algorithm; all possibilities are tested. This is particularly useful for forms that are scanned in upside down, sideways, or have scanner or photocopier induced line deformations. Those forms may be missing obvious initial line pair choices, such as the topmost line.

Fingerprinting Method 2. In another aspect of the invention, fingerprinting may be accomplished using a different method, comprising sorting the lines on both the scan of interest and the templates, initially into horizontal and vertical lines, then based on position, followed by comparing the lines from the scan with each template using dynamic programming methods. Dynamic programming methods have been developed to solve problems that have optimal solutions for sub-problems that may then be used to find the best solution for the whole problem. Dynamic programming approaches break the general problem into smaller overlapping sub-problems and solve those sub-problems using recursive analysis, then construct the best solution via a rational reuse of the solutions. In a preferred embodiment, a variant of Dynamic Time Warping (DTW), a type of Dynamic Programming, is used, but other types of Dynamic Programming known in the art are suitable and within the scope of the present invention. The variation of DTW is used to compare the scan lines with template lines and compute a similarity score.

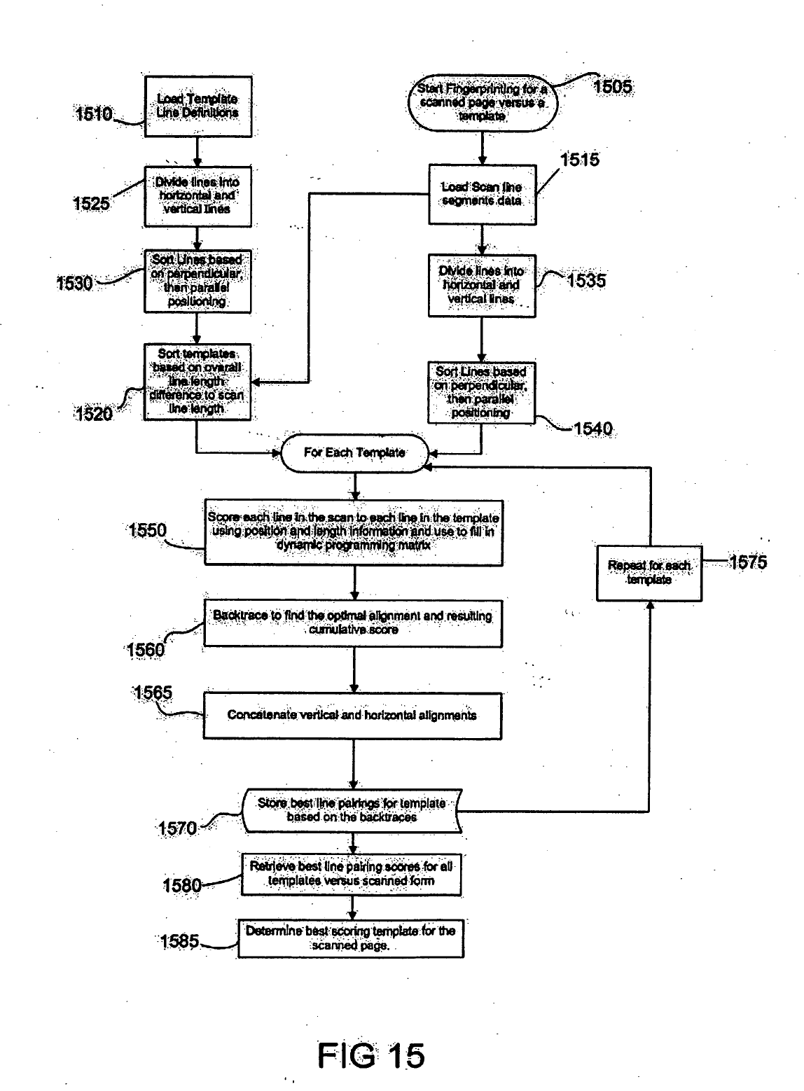

FIG. 15 is a flowchart of an embodiment of the method for fingerprinting, using dynamic programming. Referring to FIG. 15, after initialization 1505 of the process for a scanned page versus a particular template, the template line definitions 1510 and the scan line segments data 1515 are respectively loaded. The dictionary of templates is ordered 1520 according the difference between each template's overall line length and the scan image's overall line length. For each template, the line positions of each template are then separated 1525 into two classes, vertical lines and horizontal lines. Each class is then handled separately until the later steps in the process, when the results of each class are concatenated. The lines of each class are then clustered 1530 based on the perpendicular positioning, and then sorted by the parallel positioning. Hence the horizontal lines are sorted based on their Y positions, followed by their increasing X positions in cases where more than one horizontal line had roughly the same Y positioning. In the preferred embodiment, the variability of the perpendicular position was +/−5 pixels, although this variability may be expanded or contracted depending upon the density and number of lines.

The same process occurs for the scan; line positions are separated 1535 into vertical and horizontal classes, then each class is clustered 1540 by its perpendicular position and then sorted by its parallel positioning. After sorting, a matrix is created and filled 1550 using dynamic programming methods, by evaluating the costs of matching lines, gapping either the template or scan line, or merging two or more scan lines. After the matrix is filled in 1550, the backtrace process 1560 occurs, starting at the lowest right element of the matrix and proceeding through the lowest scores that are to the left, above, and above and to the left. The scores from the vertical and horizontal alignments are concatenated 1565, and the best line pairing for the template based on the backtrace 1560 is stored 1570. The entire process repeats 1575 for each template, until all templates have been evaluated against the scanned page. As the loop progresses, the best match is maintained and, if a suitable match is found, the match is returned 1580 when the loop completes and is then used to determine 1585 the best scoring template for the scanned page.

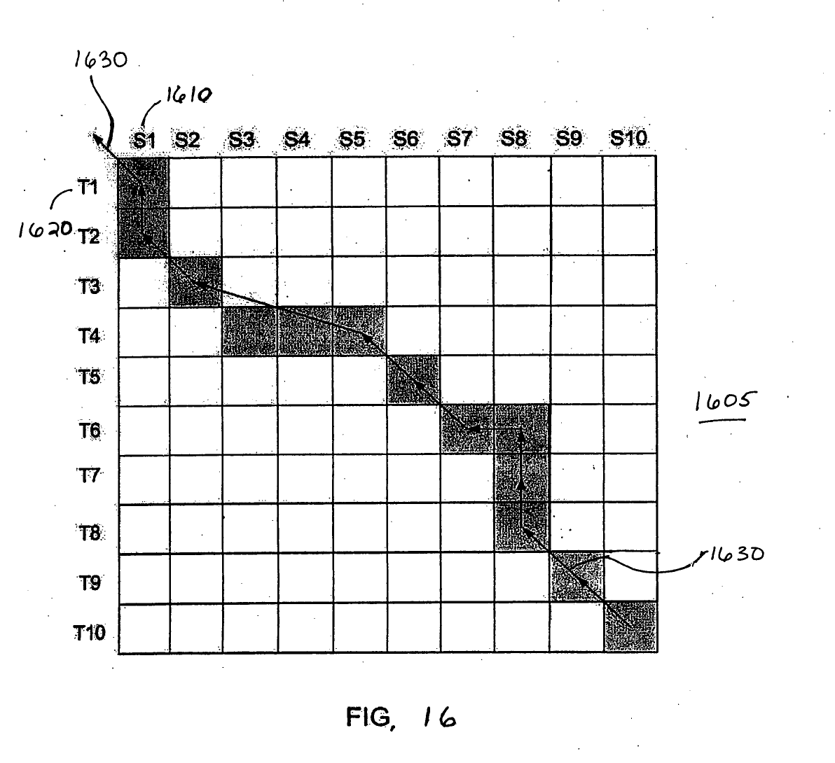

A diagram of an exemplary application of the backtrace process is shown in FIG. 16. In FIG. 16, the sorted lines of the scan are shown at the top of matrix 1605, represented by S# labels 1610, and the sorted lines of the template are shown on the left axis, represented by T# labels 1620. In this example, the best line alignment 1630 for the hypothetical template, scan pair would be T1->S1, T2->gap, T3->S2, T4->(S3,S4,S5), T5->S6, T6->S7, gap->S8, T7->gap, T8->gap,,T9->S9, and T10->S10. In particular,line T4 of the template matches lines S3, S4, and S5 of the scan, which indicates that the scan lines were segmented and were merged during the construction of the scoring matrix. Lines S8, T7, and T8 did not match any lines, potentially representing a region of poor similarity between the forms.

The two methods described herein for Fingerprinting may be used separately or in series, depending upon scans and template sets. In general, Method 1 may be more accurate with scans that are of poor quality, especially scans that are significantly skewed and/or scaled improperly. This appears to be due to the ability of the method to test many more possibilities of pairs using offsets. Method 2 appears to be more stringent with good quality scans and is theoretically able to handle slight differences in templates, for example, when versions of the same form are present in the template set. In addition, since it can run without using offsets, Method 2 is substantially. faster and less CPU intensive. Further, through the judicious use of baseline scores and appropriate PIDs and FIDs, as described later, these methods may also be used in series in order to achieve a rapid filtering of easily assigned scans, followed by a more thorough analysis of the template matches. In this manner, processing times and accuracy may be maximized.

There are a number of ways to increase the speed of the comparison algorithms of the present invention without sacrificing accuracy. Different parameters from the line definitions may be used, including the line centers as well as the endpoints, in order to enhance the speed of the calculations. Furthermore, the score of a template/scan round is the cumulative “error” that builds up as each line is compared. Another words, if the line matches exactly between the template and the scan, then the score is 0. As each line is compared, the score will additively build up. A perfect match (for example, if a template is analyzed against itself) yields a score of 0. Anything else will have a positive score.

One technique available in some embodiments to increase the efficiency and speed of the Fingerprinting algorithm is to initially place the templates that have the highest chances to be the correct template for a scan at the top of the list of templates to be tested. The library may therefore optionally be loaded or indexed in a manner to increase the chances of testing against the correct template in the first few templates tested. This is accomplished by indexing the templates such that those templates with certain line parameters, such as number of line segments and overall line length closest to that of the scan are placed at the top of the list to be tested. Hence, the templates are ranked by increasing absolute value of the difference between the template parameter and the scan parameter. Form and workflow knowledge can also be used to weight the templates in order of frequency of occurrence. In the preferred embodiment, the overall line length is used as the parameter for ranking, although other parameters, such as the total number of line segments, or average line length may be used. As the Fingerprinting process loops through each indexed template, the indexing increases the chances of hitting the correct template early in the sequence, allowing a kickout. This halts the fingerprint process for that scan, thereby minimizing the search space considerably, especially if the template set is large.

Several techniques that permit minimization of the amount of computation that is used for this process may be used in the present invention, either alone or in combination. First, by using template ordering, only templates that may be close to the correct template are initially compared. Secondly, because the score is additive and only builds up for each round of comparison, whenever the score goes above a predetermined level, the comparison stops and moves to the next comparison. Since the comparison is done in a line-by-line method, this can substantially reduce the computation load. The level is called the False Identification (FID) score. This number is determined empirically using data from scans, and is set high enough to make sure no correct hits are inadvertently “kicked out”. Since the line position and length differences scores are cumulative during the line comparison algorithm, the program can discard form offsets as soon as they begin to produce scores that are worse (higher) than the best previous score. Hence, during Step 3 for Method 1 above, if the score becomes worse than the best previous score, the loop is stopped and the program continues to the next line pair. Similar thresholds may be determined among templates. When the score becomes worse than any previous score, including from other templates, the loop is terminated and that form offset is discarded.

The False Identification Score is a score above which there is no possibility that the form instance alignment matches the template alignment. Hence, if the template tested by Fingerprinting is a poorly matching one, yet better than any previous template, the FID in this case, as defined for a template, will cause a kick out of the loop for a specific offset. The FID is used to minimize the number of alignments that are fully checked during the Fingerprinting of each template offset against the scan. By moving to the next offset, the FID-curtailed Fingerprinting significantly reduces the computing time required to Fingerprint a scan.

Another technique determines if the match between the template and the scan is giving a score that is below what is expected for a match, and hence the match is very good. In this case, then the template is considered a match and no more comparisons are required. Using template ordering, this can reduce the number of templates tested from a large number to one or a few. This limit on the score is called the Positive Identification score (PID). In Fingerprinting, line matching scores are lowest for the best matches. By determining the score levels below which a correct hit is indicated, it is possible to definitely call a correct template assignment whenever a line matching score for a full alignment stays below that determined score level. Under those conditions, the Fingerprinting for that form instance may be considered finished, as the continuation of the Fingerprinting against other templates will not yield a better (lower) score. Hence, the form is considered matched and is “kicked out” of the Fingerprinting process. The score level at which this occurs is designated the PID.

There are several levels of PIDs, including a template specific PID where each form template has its own PID, a global PID where a general PID is assigned for the template set (usually equal to the lowest template specific PID), and the PID group PID, where the score is higher than any PID of the PID group. Similar templates are clustered into a PID group. In this manner, a very large number of templates is clustered into a manageable number of PID groups. Once a member of the PID group is matched, that group of templates is used for the remainder of the analysis. Once analyzing within the PID group, more strenuous template-specific PIDs may be applied to find the specific match. This approach is important when a template set has many closely related templates. In this case, the template PIDs either have to be extremely low to avoid false positive calls, or else the initial round of PIDs may be higher, with then close analysis of related templates for highly accurate matches.

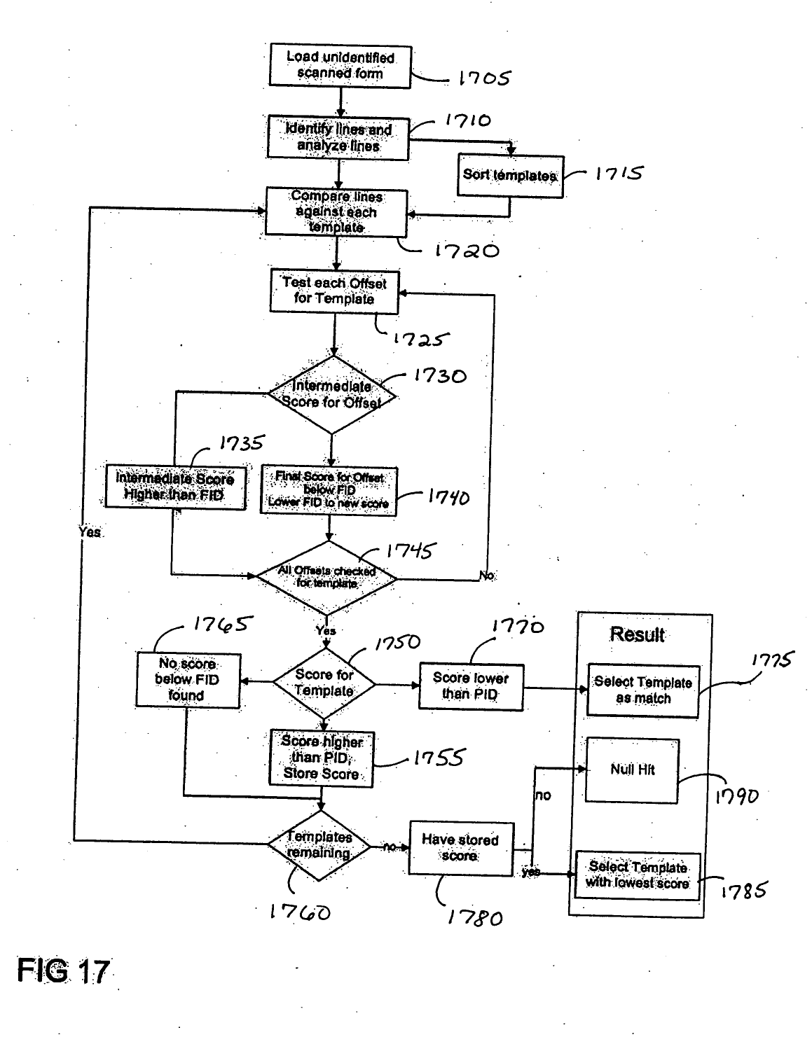

FIG. 17 is a flowchart of an embodiment of a process for using Positive Identification Scores, False Identification Scores, and Template Indexing according to one aspect of the present invention. As shown in FIG. 17, the unidentified scanned form is loaded 1705 and the lines are identified 1710 and analyzed for number, length, and overall line length. The templates are optionally sorted 1715 to preferentially test most likely matching templates first, and the lines are compared against each template 1720. Each offset for the template is tested 1725, and an intermediate score is assigned to the offset 1730. If the intermediate score is higher 1735 than the FID, the FID is left unchanged, but if the intermediate score is lower than the FID, the FID is lowered 1740 to the new score. If all offsets have not yet been checked 1745 for the template, then template offset testing 1725 is continued, but if all have been checked then the score for the template is determined 1750. If the resulting score 1750 for the template is lower than the PID 1770, then the template is selected 1775 as a match. If the score is higher than the PID and lower than the FID, the score is stored 1755. Otherwise, the score is higher than the FID 1765, and the template is not considered a potential match. If there are templates remaining 1760, the process continues, comparing 1720 the lines against the next template. When there are no templates remaining 1760, if there is a stored score 1780, the template with-the lowest score is selected 1785. If there is no stored score 1780, the process returns a null hit 1790.

In one embodiment of the present invention, knowledge about the workflow and the general population of types of forms present to be identified is applied. For example, if a set of scans is known to contain a high percentage of a few types of forms and a low percentage of another set of forms, then the index of templates may be adjusted to specifically favor the high percentage forms.

Field Mapping (step 220 of FIG. 2). In another aspect of the present invention, the Fingerprinting methods allow the identification of fields within identified scans. After Fingerprinting and upon successful identification of the scan with its template, the translation and scaling adjustments are applied to further align the form to the template. At this point, the location of the fields on the identified form may be mapped from the template to the identified scan.

Data Extraction (step 225 of FIG. 2) and Export to Database (step 240 of FIG. 2). In another aspect of the present invention, an automated data extraction method electronically captures and metatags images from the identified fields on identified forms. Another method permits the depositing of image data into a database for later retrieval and analysis. The template and location data is captured and linked to the image data.

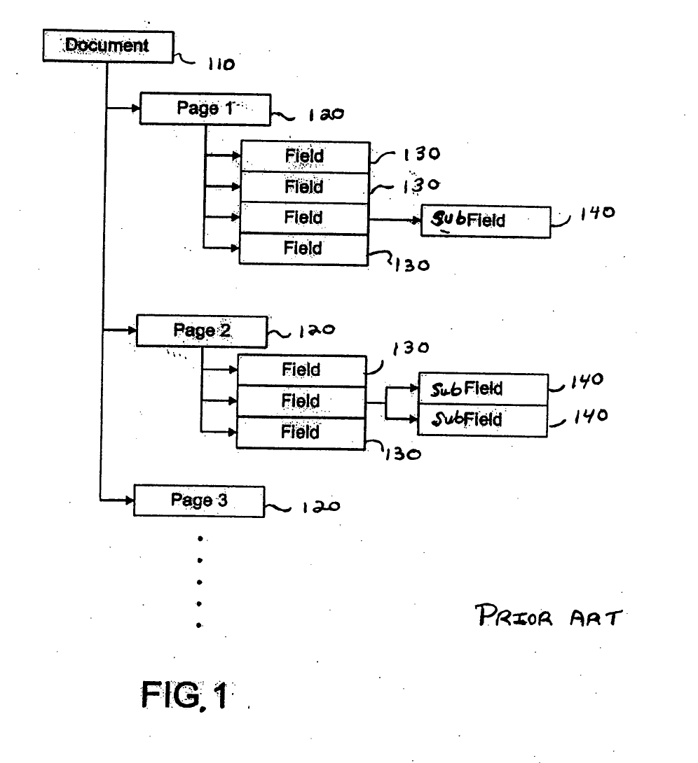

Once the scans have been identified, the template definition may be applied to those scans. As shown in FIG. 1, metadata may be applied at any or all levels. At the top levels, this includes not only the name and type of the form, but also may include any metadata that is germane to the document, page and form type. Metadata of that type may include, but is .not limited to, form ID, lexicons or lexicon sets associated with the form, publication date, publisher, site of use, and relationship to other forms, such as being part of a document or a larger grouping of forms. At the field and sub field levels, all of the positional and metadata information of the template that is tagged to the fields may be applied to the scans. This information includes, but is not limited to, the x, y positions of the fields, the name of the fields, any identifying numbers or unique ID, lexicons that are associated with the fields, whether the field is expected to contain a mark, typewritten characters (for OCR), alphanumerics for intelligent character recognition, handwriting, and images.

Template pages that have both line definitions and the field definitions then may be used to define the fields within a matched scanned or imported page. This may occur in at least two ways. First, with the appropriate offset, the field locations may be superimposed directly upon the scanned page. This approach works well for pages that have been scanned accurately or with electronically generated and filled out pages. However, in cases where the alignment of the scanned page with the template is not optimal, for example, due to slight scanning issues such as size of scan, rotation, stretching, etc., a further processing step may be used to develop the field definitions for that specific scanned page. In these cases, the mapped line definitions may be used to exactly locate the positions of the fields within the scanned form, based on the matched line segments of the template. For example, if four lines, two horizontal and two vertical, are in a template that describe a field and, within a matched scanned page, there exist the analogous four lines, then, by using the analogous lines within the scanned page, the field that corresponds to the template field can be defined. The application of small amounts of variability provides for handling scanner artifacts. Furthermore, adjustments may be made that allow positioning variations for specific lines. Hence, as forms evolve, line positioning can change, thereby still identifying the field based on a parent template while capturing the whole data from a field that is slightly shifted or changed in size.

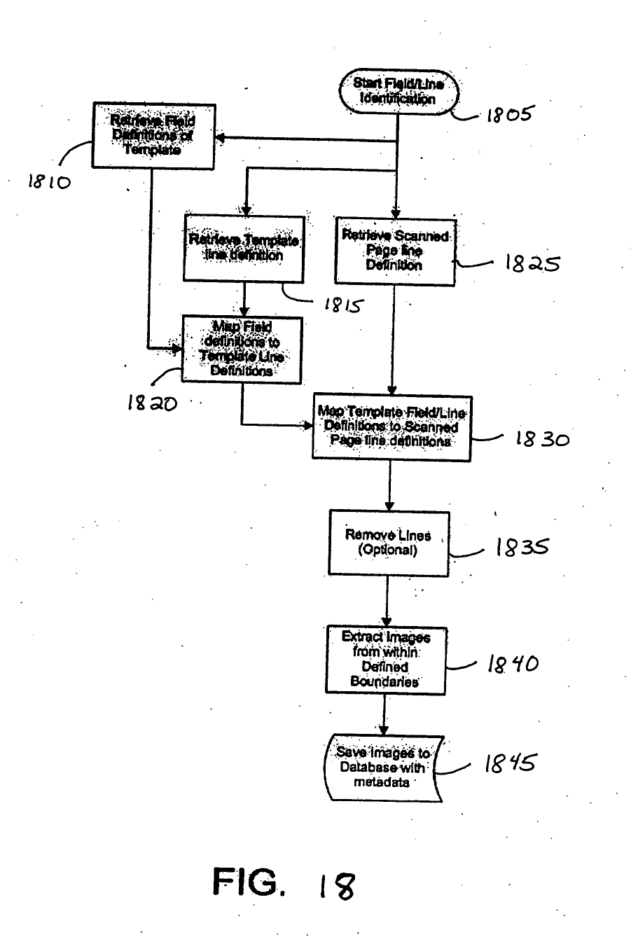

FIG. 18 is flowchart for an embodiment of a process for mapping fields and then extracting images from fields on a scanned page, according to one aspect of the present invention. In FIG. 18, the field/line identification process is initialized 1805 and the template field definitions 1810 and line definitions 1815 are retrieved. The template field definitions are then mapped 1820 to the line definitions. The scanned page line definitions are retrieved 1825 and the template field/line definitions are mapped 1830 to them. Lines may optionally be removed 1835, and then the images are extracted 1840 from within defined boundaries and saved 1845 to a database along with any associated metadata.

Recognition (step 250 of FIG. 2). In another aspect of the present invention, recognition methods are used for transforming image data into text, marks, and other forms of data. Optical Character Recognition (OCR) may be used during the Scan Identification process, both to help identify the scan of interest and also to confirm the identification based on the line scaffold comparisons. OCR is used as well once a field has been identified and the image has been extracted. The image may be subject to OCR to provide a string of characters from the field. This recognition provides data on the content of the field. The OCR output of a field or location near a field may be used to help identify, extract, and tag the field during the automatic form definition process.

Because each field can be extracted and tagged, each field, rather than the entire document, can be separately processed, whether the content of the field is typewritten, handwritten, stamp, or image. Directed RecognitionTM is the process whereby specific fields are sent to different algorithmic engines for recognition, e.g., optical character recognition for machine text, intelligent character recognition for alphanumeric handstrokes, optical mark recognition for checkboxes, image processing for images, such as handwritten diagrams, photographs, and the like, and handwriting recognition for cursive and non-cursive hand notations.

Optical Mark Recognition (OMR) is also used in several processes of this invention. OMR may be used for determining if a check box or fill-in circle has been marked. OMR may also be used to test the accuracy of form alignment. Many forms contain areas for input as marks, including check boxes, fill-in circles and the like. These check boxes and fill-in circles gather data in a binary or-boolean fashion, because either the area for the mark is filled-in (checked) or it is left blank. These input areas, each specific field area designated as mark fields in the present invention, may be located in a group or may be individually dispersed through a form. OMR is the technology used to interpret the data in those fields.

In the present invention, one embodiment consists of an optical mark recognition engine that utilizes pixel density and, in many cases, the relationship among mark fields, in order to provide a very high accuracy of detection of input marks. Furthermore, the use of the relationships among mark fields allows the identification of “cross-outs”, where the end user has changed his/her mind about the response and crossed-out the first mark in preference of a second mark on related mark fields. Additionally, the results from OMR analysis can provide the capability to access the accuracy of the scan and template alignments.

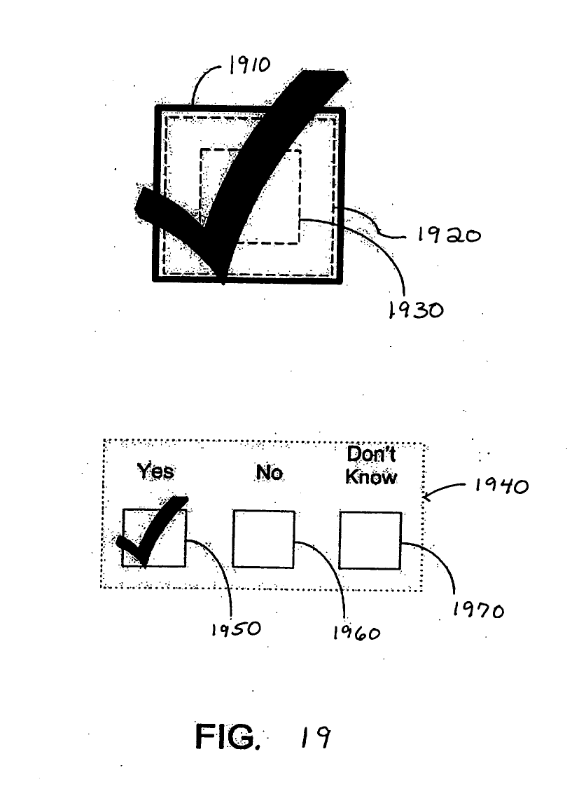

In a preferred embodiment, the pixel count of a field designated as a mark field (by comparison to the template) is adjusted to reduce the effects of border lines and to increase the importance of pixels near the center of the mark field. FIG. 19 depicts two examples of mark field inputs according to one aspect of the present invention. As shown in FIG. 19, in order to reduce the effect that slight inaccuracies of alignment have on the pixel counts due to the field boundary lines, pixels in the outer border area 1910 (corresponding to 10% of the width and height of the mark field dimensions) are not counted. The mark field is then subdivided into an outer rectangle 1920 and an inner rectangle 1930, with the inner center rectangle having optimally one half of the width and height of the outer rectangle. The total pixel count for each mark field=pixel count of the mark field+pixel count of the center rectangle. In effect, this causes the pixel count from the inner center rectangle to be weighted by a factor of two over the outer rectangle. These rectangle areas may be varied based on the accuracy of the alignment, thereby adjusting the weighting factor of the “counted” rectangle over the areas that are ignored. Furthermore, the location of the rectangles within the field may be adjusted, compensating for field shifts.

Another embodiment of the invention takes advantage of a related nature of mark fields in some forms. Often forms have more than one mark field for a specific question or data point. As shown in FIG. 19, answers to a question may require the selection of a single mark field among a group 1940 of mark fields. In FIG. 19, the answer to the hypothetical question may be “Yes” 1950, “No” 1960, or “Don't Know” 1970. In this common situation, the person filling out the form is to mark a single mark field. Due to this relationship, the pixel scores for each of the three mark fields 1950, 1960, 1970 may be compared and the highest score would be considered the marked field. The use of the relationship among mark fields allows the subtraction of backgrounds and artifacts and/or comparison of pixel scores to find the filled in mark field. These mark fields are considered a mark field group, allowing appropriate clustering and the application of mark field rules. Furthermore, the pixel score data provided by mark fields from multiple questions provide information about cross outs and even about the scan alignment to a template. In an embodiment of the invention, the average pixel score from a plurality of both marked fields and unmarked fields is taken. If a mark field group has two (or more) fields with similar high pixel scores, with both being significantly above the average of the unmarked fields, then that related set is deemed as having a cross-out. The related set may then be automatically flagged for inspection or, in many cases, the higher of the two fields is the cross out and the second highest scoring field is considered the correct mark.

If the difference between the highest pixel score and the second highest pixel score among related mark fields is small across most or all of the related mark fields within a scan, the scan may be flagged for inspection of poor alignment. Because the mark fields are so sensitive to alignment problems, the use of an algorithm to compare related mark field scores provides a very useful mechanism to automatically find poorly aligned scans. Those scans may then be aligned using either automated methods, such as fingerprinting with a different algorithm, or manually aligned. Despite the sensitivity to alignment issues, even for scans that are not well aligned and have a small difference in scores between the top two hits in related fields, the algorithm that compares the scores among related fields still, in general, can accurately predict the marked fields.

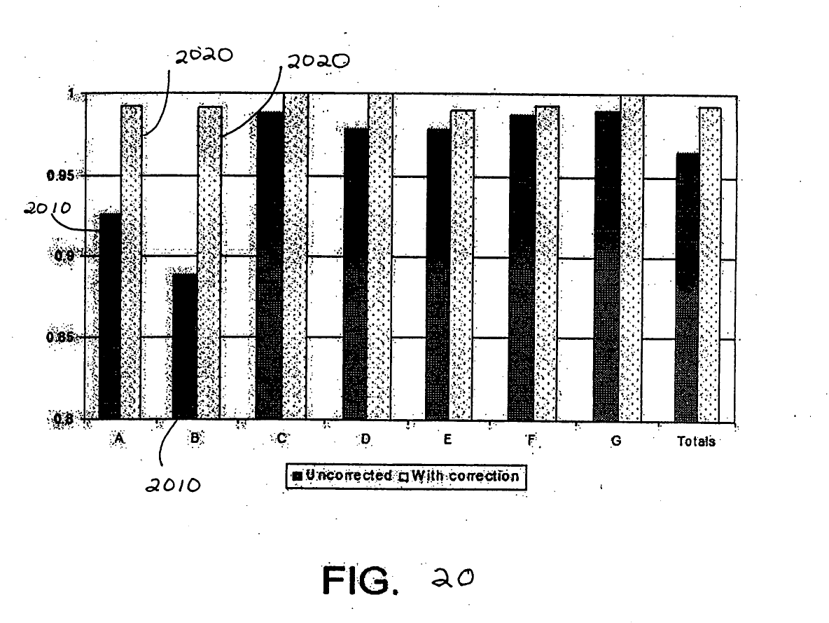

The result from combining both the OMR algorithms designed to accurately capture pixel density and rules based comparisons of those densities is shown in FIG. 20. In FIG. .20, each pair of bars in the bar chart represents the results from a plurality of scans that have been identified, aligned, and analyzed using OMR and the rules defined herein. Seven templates, A-G, are represented, each template having between 5 and 35 scan instances. Each template has between 20 and 150 mark fields, and the majority of those fields are within mark field groups having two or three members. The uncorrected bars 2010 represent the accuracy of the OMR algorithm without using the algorithms that employ the mark field rules. The accuracy varies between about 88% and 99%, based on a manual inspection of the mark fields. Upon application of the mark field rule sets to obtain corrected bars 2020, the accuracy is increased to 98 to 100%, depending upon the template.

Optical Character Recognition (OCR) may be advantageously employed in various embodiments of the present invention. The use of OCR by standard methods is readily known by one of ordinary skill in the art of data extraction, such as by applying commercially available OCR engines to images of text in order to extract machine-readable information. These engines analyze the pixel locations and determine the characters represented by the positions of those pixels. The output of these engines is generally a text string and may include positional information, as well as font and size information.

Structured forms evolve over time and workflow. Often, the same form type will be modified to accept new information or to change the location of specific information on a form. Furthermore, different users may have slightly different needs for the information type, amount of information, or sequence of information entered. These needs often result in modified forms that a quite similar and may even have the same form name and form structure. In the context of the present invention, these changes in forms are referred to as form evolution, which poses a significant challenge to both form identification and data extraction. Form evolution often makes the indexing of forms difficult if only OCR input is used as the indexing basis. In addition, forms that have only slightly evolved in structure make form identification via fingerprinting difficult as well. An embodiment of the present invention therefore combines line comparison Fingerprinting with spatially-defined OCR. This combination enhances the ability of the system to distinguish closely related or recently evolved form sets.

Spatially defined OCR is the OCR of a specific location, or locations, on a form. For example, spatially defmed OCR might be broadly located at the top 25% of a form, or the upper right quadrant of a form. In addition, specific elements defined in a template may be used for OCR. These elements may be bounded by lines, as well as represented by a pixel location or percentage location. In the majority of implementations of the present invention, the OCR is restricted to using a percentage of the location on the form, thereby not requiring the pixel values to be adjusted for each format (PDF at 72 dpi vs. Tiff at 300 dpi). Hence the X,Y location of the area to be recognized might be X=14.23%, Y=54.6%, Length=15.2%, Height=5.6%, rather than described in pixels, which will vary depending upon the dpi. However, there may be applications where the other options are preferable, and their use is considered to be within the scope of the present invention.

In a preferred embodiment, the present invention uses spatially defined OCR in several processes. OCR anchors, or specific spatially defined OCR regions, are used to confirm a Fingerprint call, as well as to differentiate between two very close form calls, such as versions of the same form. In addition, both accuracy and speed may be increased by judicious use of OCR anchors during form identification. One preferred embodiment is to group templates that are similar into a “PID Group”. The templates in the PID group are all close in line structure to each other, yet are relatively far from other templates not within the group. The name PID group is derived from the fact that the templates within the PID group will have positive identification scores that are similar and importantly, will result in positive identifications among related forms. During Fingerprinting, if any one of the PID group is matched using a PID that is unable to differentiate members of the specific group, but that is still low enough to disqualify other forms or PID groups, the form instance can then be fingerprinted with much greater accuracy against only the members of the PID group. Often, just relying on the line matching algorithms is insufficient to differentiate versions of the same form. In these cases, use of OCR anchors provides sufficient differentiation to correctly call the form type and version.

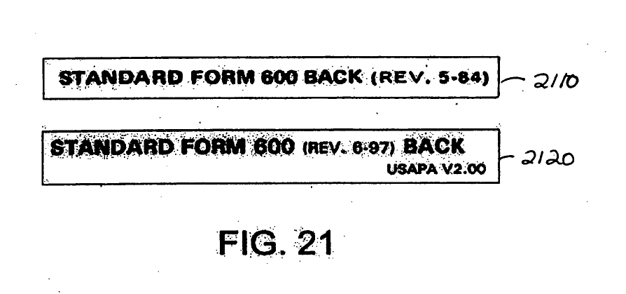

Although OCR is generally a computationally intensive activity, OCR analysis of a small region of a form, with usually less than 100 characters is quite rapid. Hence, using OCR anchors to rapidly differentiate PID groups and other closely related forms (versions and the like) provides-the added benefit of increased throughput of forms. This is because OCR analysis of less than 100 characters is significantly faster than line matching whole forms to a high degree of accuracy. Once the OCR of the OCR anchor for a form instance is done, it may be rapidly compared with multiple corresponding OCR anchors within a group of templates, without having to do any more OCR. FIG. 21 depicts anchors from two highly similar forms 2110 and 2120 (both being versions of Standard Form 600, form 2110 being revision 5-84 and form 2120 being revision 6-97). By using the OCR anchors from the same positions on the forms, the version differences are readily discerned. In cases where the best Fingerprinting score is between the PID and the FID, OCR anchors may be used to verify a match.

Unidentified scan clustering. One difficult issue that may occur during form identification is that of an incomplete template set. This occurs when one or more form instances are without the corresponding templates. Under those circumstances, generally Fingerprinting will result in null hits for those forms that don't have templates. In cases where only one or two form templates are missing, simple viewing of the null hits usually provides sufficient information to allow a user to identify the missing template and to take action to secure the form for templating and form definition. However, in cases where multiple forms are missing, or where there are a high percentage of unstructured forms or images, then finding the specific forms that need templates may be very time consuming.

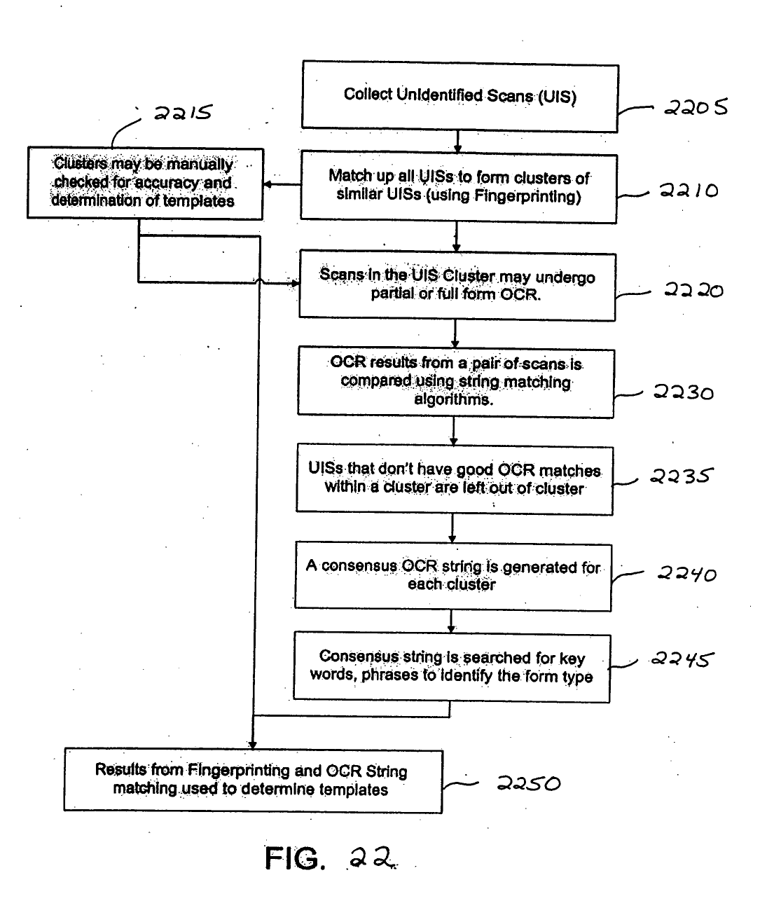

To facilitate the identification of forms that are missing from the template set, one aspect of the present invention employs a process, known as Cluster UIS (Unidentified Scan), that determines which unidentified scans may be represented a plurality of times within a large set of scans undergoing identification, as well as providing information about the form type and name. A flowchart of this process is depicted in FIG. 22. In FIG. 22, forms that have undergone fingerprinting and ended up as null hits (and designated UIS) are marked as such and stored 2205. When the number of null hits reaches a critical number, as defined by the end user, then each null hit is Fingerprinted against the other null hits. The number of UIS is generally more than 10, and then depends upon the percentage of the total number of scans that the UIS. represents. As fingerprinting is occurring, if the UIS count is more than 20-30% of the number of scans, then a fingerprinting run may be stopped and Cluster UIS may be employed to identify missing templates. Alternatively, Cluster UIS may be employed at the end of the fingerprinting run. Any scans that then have matches with other scans, based on amuser-defined PID, are placed 2210 in a UIS cluster. This clustering is based on the line segments that are identified with the fingerprinting process. At this point, a user may choose to visually inspect 2215 the clusters and proceed to either locate a potential form template from another source, or to generate a template using one or more of the UIS scans within the cluster.

The scans within a cluster may then undergo partial or full form OCR 2220, providing a string of characters. These strings from the scans within a UIS cluster are then compared 2230 using a variety of algorithms to identify similarities. It has been determined that the Needleman-Wunsch Algorithm works well, although other alignment and matching algorithms known in the art may also be advantageously used. If the OCR results do not match reasonably well, then the non-matching UIS is removed from the cluster 2235. In general, unstructured forms will not cluster, thereby allowing the user to identify only those forms with structured elements, and those are likely to be the forms that may have templates available.

To further assist the user in identifying unknown and absent templates, the OCR output from each cluster may be analyzed to provide clues about the template from whence the UIS originated. The OCR of each form within a cluster, as validated by reasonable scores on either or both the Fingerprinting and the text alignment, are combined to generate 2240 a consensus string for the cluster. The consensus string may then be searched 2245 with known text strings of missing forms, such as key words, names, or titles. Furthermore, when using standardized forms, often a search of the consensus string for letters, particularly in the early part of the string (corresponding to the upper left corner of the form) or the later part of the string (corresponding to the bottom of the form), such as “Form” or “ID” will locate terms that may be of assistance in determining the form identity. Finally, the results from Fingerprinting and OCR string matching are used to identify 2250 a form template.

Rules Development (step 230 of FIG. 2) and Application (step 235 of FIG. 2). In another aspect of the present invention, business logic may be developed and applied at multiple levels during the overall process. For example, simple rules, such as mark field rules, may be introduced for a series of check boxes, e.g., where only one of a set of boxes in a group may be checked. Also, data can be linked to one another for search and data mining, e.g., a “yes” checkbox is linked to all data relevant to the content and context of that checkbox. This aids in semantics, intelligent search, and computation of data. Furthermore, once OCR has been performed, spreadsheet input may be verified using a set of rules; e.g., some of the numerical entries in a row may need to add up to the input in the end field of the row. In addition, the validation of input, and hence of OCR, may extend across multiple pages of forms and even across documents.

Quality Control (step 245 of FIG. 2). In another aspect of the present invention, the application of rules allows for a considerable amount of automated quality control. Additional quality control consists of generating output from the rules applications that allow a user to rapidly validate, reject, or edit the results of form identification and recognition. By defining the field locations and content possibilities within the template, tight correspondence between the template and the scanned page is possible on at least two levels, by making sure that both the form identification. and the data extraction are correct. An example of the multi-level validation of form identification would include identification based on line analysis and fingerprinting, as well as OCR analysis of key elements within the form. These elements might include, but are not limited to, the title of the form, a serial number, or a specific field containing a date or a social security number that is recognized. For example, if the data extraction gives a long string or a lot of data for what the field content definition presumes to be a small field, then an error flag might result, notifying an editor of a potential issue either with the form identification or the input of that specific field. Strings of OCR text helps verify form identification and line fingerprinting appropriately maps geographic and field-to-field spatial relationships.

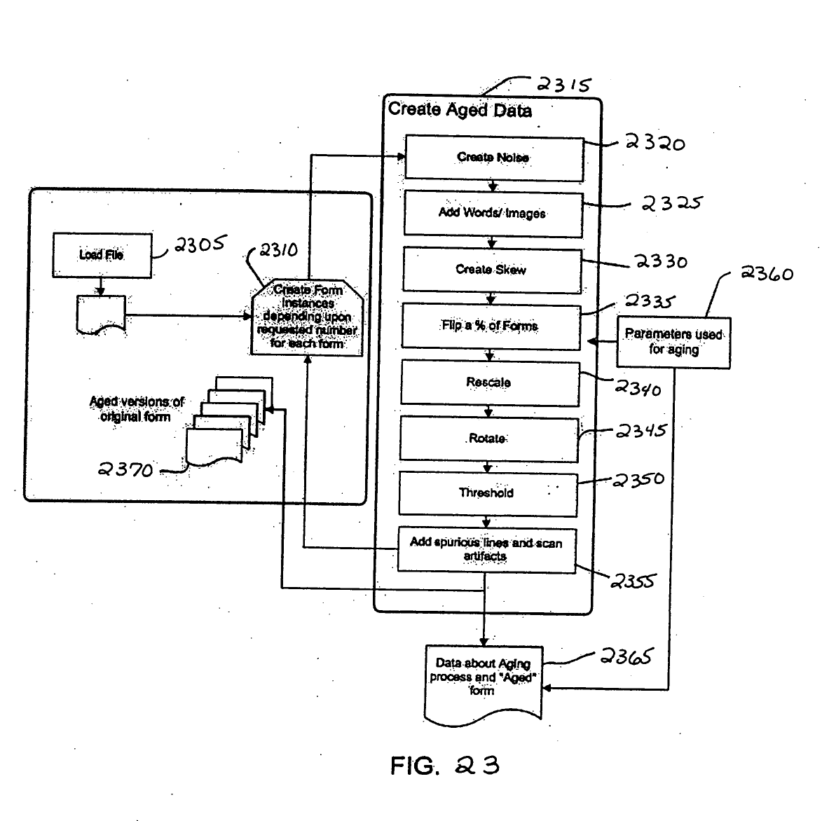

Test harness. Another aspect of the present invention is a system for generation of large sets of well-controlled altered versions of scans. These sets of altered versions are then used to test and optimize various parameters of the algorithms involved in line identification, fingerprinting, OMR, OCR, and handwriting recognition. The alterations are designed to mimic the effects of aging and use, as exemplified by, but not limited too, poor scanning, scanning at low resolution, speckling, and image deterioration, such as the appearance of stains and smudges, the fading of parts or all of the typing and images, overwriting, and notes. The system of this aspect of the present invention provides a large amount of raw data from which many of these parameters may be extracted. This process is the form aging process, depicted as a flowchart in FIG. 23.

As shown in FIG. 23, an image is loaded 2305 from a file and a number of image duplicates are created 2310. Each image is then submitted to aging process 2315, where it is digitally “aged” and scan artifacts are introduced by altering the pixel map of the image using a variety of algorithms. These include, but are not limited to, algorithms that create noise 2320 within the image, add words, writing, images, lines, and/or smudges 2325, create skew 2330, flip a percentage of the images by 90 or 180 degrees 2335, rescale the image 2340, rotate the image by a few degrees in either direction 2345, adjust image threshold 2350, and add other scan artifacts and spurious lines 2355. Each instance of the original form is adjusted by one or a plurality of these algorithms, using parameters set by the user. In the preferred embodiment, a range of parameters is automatically generated for the aging process, using parameters within the range. The exact parameters 2360 chosen for each aged instance of the form are stored 2365 in the database as metadata, along with the aged instance of the form. Preferably, multiple aged instances 2370 are created for each original form, thereby generating a large set of form versions, each with well-defined aging parameters.

One major use for the aged versions of the forms is to examine how effectively various parts of the form identification process can handle scan and “aging” artifacts that are encountered in real world form identification situations. This analysis then allows the optimization of the form identification processes for those artifacts. The general approach is to take a template or scanned image (the original), make a series of modified images from that original, and then use those modified images as form instances in the form identification processes. The results of the form identification processes are then tabulated with the modifications that were made to the original. The resulting data may be analyzed to understand the effects of the modifications, both individually as well as in combination on the form identification processes. Furthermore, the modified images may be tested against other processes, such as OCR and OMR, again to understand the effects of modification on the accuracy and effectiveness of those processes.

The present invention provides a document analysis system that facilitates entering paper documents via scanning into an electronic system in an efficient manner, capturing and storing the data from those documents in a manner that permits location of needed data and information while keeping whole documents and document groups intact, that adapts to form variation and evolution, and that has flexible information storage so that later adjustments in search needs may be accommodated. Stored electronic forms and images can also be processed in the same or similar manner. The system of the present invention minimizes manual effort, both in the organization of documents prior to scanning and in the required sorting and input of data during the data capture process. The system further provides new automated capabilities with high levels of accuracy in form recognition, field extraction, with subsequent salutary effects on recognition.

The present invention is preferably implemented in software, but it is contemplated that one or more aspects of the invention may be performed via hardware or manually. The invention may be implemented on any of the many platforms known in the art, including, but not limited to, MacIntosh, Sun, Windows or Linux PC, Unix, and other Intel X-86 based machines, and in the preferred embodiment is implemented on a Windows and Linux PC based machines, including desktop, workstation, laptop and server computers. If implemented in software, the invention may be implemented in any of the many languages, scripts, etc. known in the art, including, but not limited to, Java, Javascript, C, C++, C#, Ruby, and Visual Basic, and in the preferred embodiment is implemented in Java/Javascript, C, and C++. Examples of the currently preferred implementation of various aspects of an embodiment of the present invention are found in the computer program listing appendix submitted on Compact Disc that is incorporated by reference into this application.

While a preferred embodiment of the present invention is disclosed, many other implementations will occur to one of ordinary skill in the art and are all within the scope of the invention. Additionally, each of the various embodiments described above may be combined with other described embodiments in order to provide multiple features. Furthermore, while the foregoing describes a number of separate embodiments of the apparatus and method of the present invention, what has been described herein is merely illustrative of the application of the principles of the present invention. Other arrangements, methods, modifications, and substitutions by one of ordinary skill in the art are therefore also considered to be within the scope of the present invention, which is not to be limited except by the claims that follow.

What is claimed is:

1. A computer-readable medium, the medium being characterized in that:
the computer-readable medium contains code which, when executed in a processor, performs document analysis by the steps of:
electronically receiving at least one input scan containing at least one field for containing data;
analyzing the input scan to identify lines and fields within the input scan, by the steps of:
locating at least one. shaded region or line segment;
filtering any shaded region found;
detecting and filling in any gaps in any located line segment;
clustering any line segments co-located within a specified shift distance; and
determining a length and a location for each line segment or line segment cluster;
comparing the analyzed input scan against a library of form templates;
identifying the form template that best matches the input scan;
based on the identified form template, identifying at least one field or line within the input scan; and
extracting data from the identified field or line.

2. The computer-readable medium of claim 1, the medium further being characterized in that:
the computer-readable medium contains code which, when executed in a processor, performs the step of:
defining a plurality of templates for the form template dictionary, each template describing an individual form type in terms of at least the location of at least one field or line on a form having the individual form type.

3. The computer-readable medium of claim 1, the medium further being characterized in that:
the computer-readable medium contains code which, when executed in a processor, performs the step of:
applying rules for validation and automatic editing established for the identified template to the extracted data.

4. The computer-readable medium of claim 1, the medium further being characterized in that:
the computer-readable medium contains code which, when executed in a processor, performs the step of:
exporting the extracted data for validation and editing using a quality control system.

5. The computer-readable medium of claim 1, the medium further being characterized in that:
the computer-readable medium contains code which, when executed in a processor, performs the step of:
applying field specific business and search rules to the extracted data.

6. The computer-readable medium of claim 1, the medium further being characterized in that:
the computer-readable medium contains code which, when executed in a processor, performs the step of:
performing individual recognition activities in order to convert extracted data into a searchable and computable format.

7. The computer-readable medium of claim 1, the medium further being characterized in that:
the computer-readable medium contains code which, when executed in a processor, performs the step of extracting data by means of optical recognition.

8. The computer-readable medium of claim 1, the medium further being characterized in that:
the computer-readable medium contains code which, when executed in a processor, performs the step of identifying the form template that best matches the input scan by the step of:
discriminating between different versions of the same form type.

9. A computer-readable medium, the medium being characterized in that:
the computer-readable medium contains code which, when executed in a processor, matches an input scan to a form template by the steps of:
for every line segment identified on the input scan,
comparing the position and length of the line segment with at least one line definition from a form template contained in a form template library; and
determining the offset between the input scan line segment and the form template line definition;
using the determined offsets for all input scan line segments, determining a score related to the goodness of fit between the input scan and the form template; and
determining which form template most closely matches the input scan by comparing the score for each form template against scores for other form templates in the form template library.

10. The computer-readable medium of claim 9, the medium further being characterized in that:
the computer-readable medium contains code which, when executed in a processor, performs the step of:
setting a threshold score below which a form template will be immediately considered a match and the process will be terminated early.

11. The computer-readable medium of claim 9, the medium further being characterized in that:
the computer-readable medium contains code which, when executed in a processor, performs the step of:
setting a threshold score above which a form template cannot be considered a match and consideration of that form template will be terminated early.

12. A computer-readable medium, the medium being characterized in that:
the computer-readable medium contains code which, when executed in a processor, matches an input scan to a form template by the steps of:
determining an overall line length of identified line segments on the input scan;
ordering form templates in a form template library by comparing the overall line length definition for each template to the input scan overall line length;
separating the input scan line segments into a vertical line class and a horizontal line class;
ordering each class by clustering the perpendicular positioning of each line segment in the class and then sorting each cluster by the parallel positioning of each line segment in the cluster;
beginning with the first form template according to the form template order and employing dynamic programming methodologies, determining an alignment and score for each of the vertical and horizontal line classes based on comparisons of line position and length;
concatenating the alignments from the vertical and horizontal classes to obtain an overall score for the form template;
if more form templates remain in the library, repeating for each form template; and
determining which form template most closely matches the input scan by comparing the overall score for each form template against scores for other form templates in the form template library.

13. The computer-readable medium of claim 12, the medium further being characterized in that:
the computer-readable medium contains code which, when executed in a processor, performs the step of:
setting a threshold score below which a form template will be immediately considered a match and the process will be terminated early.

14. The computer-readable medium of claim 12, the medium further being characterized in that:
the computer-readable medium contains code which, when executed in a processor, performs the step of:
setting a threshold score above which a form template cannot be considered a match and consideration of that form template will be terminated early.

15. A computer-readable medium, the medium being characterized in that:
the computer-readable medium contains code which, when executed in a processor, performs form template definition by the steps of:
electronically receiving an instance of a new form type;
identifying at least some lines, boxes, or shaded regions located within the form instance;
determining a location and size for each identified line, box, or shaded region;
from the location and size determined for the identified lines, boxes, or shaded regions, defining at least one form field having an associated- form field location;
optionally recognizing any text within each defined form field;
based on the content of any recognized text for a form field and the associated form field location, assigning an associated form field identifier and an associated form field content descriptor for each form field; and
storing the line locations, form field identifiers, associated form field locations, and associated form field content descriptors to define a form template for the new form type.

16. The computer-readable medium of claim 15, the medium further being characterized in that:
the computer-readable medium contains code which, when executed in a processor, performs the step of:
defining a second form template for a second form type from the defined form template by the steps of:
identifying at least one second form type form field that, based at least on form field location, matches a defined form field from the defined form template; and
transferring the form field identifier and associated form field content descriptor for the matching defined form field from the defined form template to the second form template.

17. The computer-readable medium of claim 15, the medium further being characterized in that:
the computer-readable medium contains code which, when executed in a processor, performs the step of:
cleaning up scan artifacts, stray marks, or smudges on the received form instance prior to defining the form template.

18. The computer-readable medium of claim 15, the medium further being characterized in that:
the computer-readable medium contains code which, when executed in a processor, performs the step of:
exporting the defined form template for validation and editing using a quality control system.

19. The computer-readable medium of claim 15, the medium further being characterized in that:
the computer-readable medium contains code which, when executed in a processor, performs the step of identifying by the steps of:
locating at least one shaded region or line segment;
filtering any shaded region found;
detecting and filling in any gaps in any located line segment;
clustering any line segments co-located within a specified shift distance; and
determining a length and a location for each line segment or line segment cluster.

20. A computer-readable medium, the medium being characterized in that:
the computer-readable medium contains code which, when executed in a processor, performs identification of unidentified input scans by the steps of:
identifying a plurality of input scans that have failed to be matched to a template during a document analysis procedure;
performing a document analysis procedure by selecting one unidentified input scan as a template and using the remaining unidentified input scans as input scans;
placing any input scans that match into an unidentified input scan cluster; and
matching the unidentified input scan cluster to an existing form template from another source or to a new form template defined using the unidentified input scan cluster.

21. The computer-readable medium of claim 20, the medium further being characterized in that:
the computer-readable medium contains code which, when executed in a processor, performs the step of matching the unidentified input scan cluster to a form template by the steps of:
performing character recognition on each unidentified input scan within an unidentified input scan cluster to obtain strings of characters;
comparing strings from each scan within the cluster to identify similarities;
if strings from a particular scan do not match strings from the other scans within a specified tolerance, removing the particular scan from the cluster;
generating a set of consensus strings for the cluster, based on the content of the strings obtained for each form within the cluster as validated by scores from template matching or text alignment procedures;
searching the consensus string with known text strings from missing forms to locate terms that may be of assistance in determining the form identity; and
based on results obtained from template, text alignment, and character string matching, identifying a matching existing form template or creating a new form template that matches the unidentified form scan cluster.

22. The computer-readable medium of claim 20, the medium further being characterized in that:
the computer-readable medium contains code which, when executed in a processor, performs the step of matching the unidentified input scan cluster to a form template by the step of:
exporting the cluster for visual inspection and matching.
